(19) United States
(12) Patent Application Publication
(10) Pub. No.: US 2026/0005799 A1
(43) Pub. Date: Jan. 1, 2026

(54) ACTIVATION AND DEACTIVATION OF SEMI-PERSISTENT SCHEDULING USING MULTI-CELL TECHNIQUES

(71) Applicant: INTEL CORPORATION, Santa Clara, CA (US)

(72) Inventors: Yi WANG, Beijing (CN); Yingyang LI, Beijing (CN); Gang XIONG, Portland, OR (US)

(73) Assignee: INTEL CORPORATION, Santa Clara, CA (US)

(21) Appl. No.: 18/881,300

(22) PCT Filed: Aug. 3, 2023
(86) PCT No.: PCT/US2023/071625

§ 371 Date: Jan. 5, 2025

(30) Foreign Application Priority Data
Aug. 4, 2022 (WO) PCT/CN2022/110199

(51) Int. Cl. H04L 1/1607; H04L 5/00; H04W 72/11; H04W 72/232

(52) U.S. Cl. CPC H04L 1/1614; H04L 5/0044; H04W 72/11; H04W 72/232

(57) ABSTRACT

This disclosure describes systems, methods, and devices related to semi-persistent scheduling (SPS) or configured grant (CS). A device may decode a configuration for a Downlink Control Information (DCI) format for multi-cell scheduling. The device may detect the DCI format. The device may validate the DCI based on whether it is scrambled with a CS-RNTI or a specific RNTI. The device may activate a semi-persistent scheduling physical downlink shared control channel (SPS PDSCH) reception or a Type 2 configured grant physical uplink shared channel (CG PUSCH) transmission. The device may release for the SPS PDSCH reception or the CG PUSCH transmission based on the validation of the DCI.

### CROSS-REFERENCE TO RELATED PATENT APPLICATION(S)

This application claims the benefit of PCT Provisional Application No. PCT/CN2022/110199, filed Aug. 4, 2022, the disclosure of which is incorporated herein by reference as if set forth in full.

### TECHNICAL FIELD

This disclosure generally relates to systems and methods for wireless communications and, more particularly, to activation and deactivation of semi-persistent scheduling (SPS) using multi-cell techniques.

### BACKGROUND

Wireless devices are becoming widely prevalent and are increasingly requesting access to wireless channels. Open RAN Alliance (O-RAN) is committed to evolve radio access networks. The O-RAN will be deployed based on 3GPP defined network slicing technologies.

### BRIEF DESCRIPTION OF THE DRAWINGS

FIGS. 1-5 depict illustrative schematic diagrams for new radio (NR), in accordance with one or more example embodiments of the present disclosure.

FIG. 6 illustrates a flow diagram of a process for an illustrative NR system, in accordance with one or more example embodiments of the present disclosure.

FIG. 7 illustrates an example network architecture, in accordance with one or more example embodiments of the present disclosure.

FIG. 8 schematically illustrates a wireless network, in accordance with one or more example embodiments of the present disclosure.

FIG. 9 illustrates components of a computing device, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

New radio (NR) supports a wide range of spectrum in different frequency ranges. It is expected that there will be increasing availability of spectrum in the market for 5G Advanced possibly due to re-farming from the bands originally used for previous cellular generation networks. Especially for frequency range (FR1) bands, the available spectrum blocks tend to be more fragmented and scattered with narrower bandwidth. For FR2 bands and some FR1 bands, the available spectrum can be wider such that intra-band multi-carrier operation is necessary. To meet different spectrum needs, it is important to ensure that these scattered spectrum bands or wider bandwidth spectrum can be utilized in a more spectral/power efficient and flexible manner, thus providing higher throughput and decent coverage in the network.

One motivation is to increase flexibility and spectral/power efficiency on scheduling data over multiple cells including intra-band cells and inter-band cells. The current scheduling mechanism only allows scheduling of single cell physical uplink shared channel (PUSCH)/physical downlink shared channel (PDSCH) per a scheduling downlink control information (DCI). With more available scattered spectrum bands or wider bandwidth spectrum, the need of simultaneous scheduling of multiple cells is expected to be increasing. To reduce the control overhead, it is beneficial to extend from single-cell scheduling to multi-cell PUSCH/PDSCH scheduling with a single scheduling DCI. More specifically, a DCI is used to schedule PDSCH or PUSCH transmissions in more than one cell or component carrier (CC), where each PDSCH or PUSCH is scheduled in one cell or CC.

Example embodiments of the present disclosure relate to systems, methods, and devices for activation and release of semi-persistent scheduling (SPS) PDSCH and configured grant (CG) PUSCH using multi-cell scheduling.

5G defines the use of the CG scheduling for uplink (UL) transmissions that eliminates the need to request and assign resources for each packet transmission by pre-allocating resources to the UE. For UL there are two different types of mechanism called Type 1 and Type 2. In Type 2, a gNB sends RRC (RRCSetup or RRCReconfiguration) configuring the parameters necessary for PUSCH transmission. When gNB wants to activate PUSCH transmissions, it sends DCI masked with CS-RNTI. Once UE processes the DCI with CS-RNTI with validation of activation information, it is supposed to transmit PUSCH based on the activation information.

In one or more embodiments, an NR system may support control of SPS PDSCH, CG PUSCH, Scell dormancy, TCI update, HARQ-ACK feedback by a DCI for multi-cell scheduling.

In one or more embodiments, an NR system may facilitate mechanisms for a multi-cell scheduling downlink control information (DCI) transmission and HARQ-ACK feedback without PDSCH.

In one or more embodiments, an NR system may facilitate DCI design and validation for a multi-cell scheduling DCI without PDSCH.

In one or more embodiments, an NR system may facilitate HARQ-ACK feedback for a multi-cell scheduling DCI without PDSCH.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

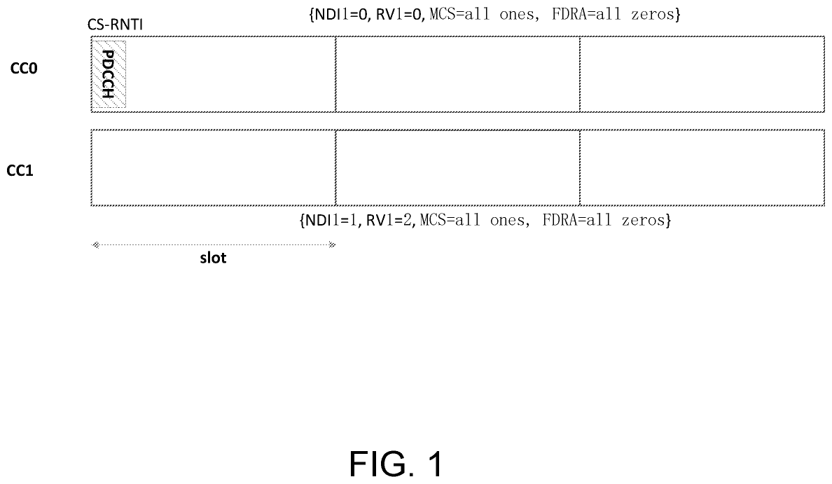

FIGS. 1-5 depict illustrative schematic diagrams for SPS, in accordance with one or more example embodiments of the present disclosure.

In new radio (NR) system, a downlink (DL) downlink control information (DCI) only schedules a physical downlink shared channel (PDSCH) or multiple PDSCHs on an active DL bandwidth part (BWP) of a cell. It should be noted that a BWP is a contiguous set of physical resource blocks (PRBs) on a carrier. In simpler terms, it's a specific slice or portion of the total available frequency spectrum in a cell that a base station (gNB) can allocate to a device (UE, User Equipment) for communication.

In addition to scheduling of PDSCH/PUSCH, a DCI for multi-cell scheduling may also be used for another control purpose without PDSCH, e.g., semi-persistent scheduling (SPS) release, Scell dormancy, TCI update, type-3 HARQ-ACK feedback and HARQ-ACK retransmission without PDSCH. The DCI for multi-cell scheduling may also be used for SPS activation and SPS retransmission. When a UE is connected to multiple cells (primary cell (Pcell) and one or more secondary cells (Scells)) through carrier aggregation and dual connectivity, some of these Scells might not be actively used all the time, depending on the network conditions and the UE's data requirements. If a Scell is not serving any data to the UE or its capacity is not needed, the network can put that Scell into dormancy or low-power mode

In NR systems, the DCI is transmitted from the base station (gNB) to the user equipment (UE) in order to schedule the transmission of the data, typically on the physical downlink shared channel (PDSCH). In addition to scheduling PDSCH, DCI in NR can also be used for multi-cell scheduling. This is useful in scenarios where a UE is connected to multiple cells for better reception and data rates. The gNB can thus efficiently schedule resources across these different cells.

For a multi-cell scheduling DCI, whether a common or separate bit field for each PDSCH is pre-defined or configured by gNB, with the tradeoff between DCI payload and scheduling flexibility. For example, for co-scheduled carries with similar channel characteristics, e.g., intra-band CA with the same SCS, one common MCS and FDRA bit field for all carries would be sufficient, while separate HARQ process number (HPN), redundancy version (RV), new data indicator (NDI) for each carrier is still needed to enable flexible scheduling. Alternatively, one common MCS, FDRA, HPN bit field for all carriers would be sufficient, while separate NDI and RV for each carrier are still needed.

In the context of NR, the use of DCI for control purposes without scheduling PDSCH and for SPS PDSCH via multi-cell scheduling is an important consideration. This can be configured with either shared or separate bit fields.

The decision to use shared or separate bit fields in DCI for multi-cell scheduling depends on several factors, including the channel characteristics, the multi-cell configuration specifics, the required level of scheduling flexibility, and the trade-off between the DCI payload size and this flexibility.

Shared bit field configuration employs one common bit field (like MCS, FDRA, or HPN) for all carriers, which can be more efficient but may reduce scheduling flexibility. On the other hand, separate bit field configuration assigns different bit fields to different carriers, offering more scheduling flexibility but resulting in a larger DCI payload. The specifics of supporting these different requirements with multi-cell scheduling DCI are typically outlined in the network's design and configuration, which can be tailored to best meet the needs of the specific use case or scenario.

In one or more embodiments, an NR system may facilitate multi-cell scheduling DCI without dynamic scheduled PDSCH or PUSCH.

In legacy NR system, a single-cell scheduling DCI can support the following cases:
Dynamically schedule a PDSCH (DG PDSCH) or PUSCH (CG PUSCH) with C-RNTI.
Activate/release an SPS PDSCH/Type 2 configured grant (CG) PUSCH, and retransmission of SPSPDSCH/CG PUSCH.
Purely for control, e.g., indicate Scell dormancy, TCI update, Type-3 HARQ-ACK codebook, or retransmission of HARQ-ACK codebook without scheduling PDSCH.

The above belongs to the case without dynamic scheduled PDSCH or PUSCH. For easy description, even for 1^{st} SPS PDSCH/Type-2 CG PUSCH after SPS PDSCH/CG PUSCH activation, it is not considered a dynamic scheduled PDSCH/PUSCH.

In one or more embodiments, an NR system may facilitate multi-cell scheduling DCI without dynamic scheduled PDSCH or PUSCH, if the multi-cell scheduling indicates a single cell.

In one embodiment, multi-cell scheduling DCI supports at least some cases of the above cases, if the multi-cell scheduling indicates a single cell, e.g., carrier indicator bit field indicates a single cell. In one option, the UE may validate the activation/release for SPS PDSCH or CG PUSCH by a DCI, only if the DCI indicates a single cell. For example, if the DCI is scrambled with CS-RNTI, and the carrier indication field in the DCI indicates single cell, the UE checks the bit field for HARQ process number (HPN)/redundancy version (RV)/new data indicator (NDI) (if single SPS PDSCH/CG PUSCH is configured for a cell) or RV/NDI (if multiple SPS PDSCH/CG PUSCH are configured for a cell) for SPS PDSCH or CG-PUSCH activation. If the validation is achieved, the SPS PDSCH or CG PUSCH on the indicated cell is activated. The activated SPS PDSCH or CG PUSCH configuration index is determined by HPN. Alternatively, the SPS PDSCH configuration or CG-PUSCH configuration on serving cell c is activated. The serving cell c can be determined by SPS PDSCH or CG-PUSCH configuration table for activation. For a row of SPS PDSCH or CG-PUSCH configuration tables for activation, the SPS PDSCH or CG-PUSCH configuration index and the serving cell c index can be configured.

In another example, if the DCI is scrambled with CS-RNTI, and the DCI carrier bit field indicates a single cell, UE checks the bit field for HPN/RV/NDI/MCS/FDRA or RV/NDI/MCS/FDRA for SPS release. If the validation achieves, the SPS PDSCH(s) on the indicated cell is released. The released SPS PDSCH configuration index(s) for the indicated cell is determined by HPN and SPS PDSCH configuration table for the indicated cell. Alternatively, the SPS PDSCH configuration(s) on one serving cell c or a set of serving cells is released. The serving cell c or the set of serving cells and SPS PDSCH configuration(s) for release can be determined by HPN. Specifically, for each HPN value, the to-be-released SPS PDSCH configuration(s) and the serving cell c or the set of serving cells can be configured by high layer signaling.

In one option, for SPS PDSCH/CG PUSCH retransmission, the UE expects the DCI to indicate a single cell. SPS PDSCH/CG PUSCH retransmission is applied to SPS PDSCH/CG PUSCH in the indicated single cell.

In one option, for Scell dormancy indication without PDSCH, the UE considers the multi-cell scheduling DCI scrambled with C-RNTI or MCS-C-RNTI as indicating Scell dormancy, not scheduling a PDSCH reception, only if the DCI indicates a single cell.

In one option, for Scell dormancy indication without PDSCH, UE considers the multi-cell scheduling DCI scrambled with C-RNTI or MCS-C-RNTI as indicating Scell dormancy, not scheduling a PDSCH reception, only if the DCI is detected on Pcell and it indicates a single cell and the corresponding bit field such as one-shot HARQ-ACK request field and FDRA bit field is with specific code point as defined in Clause 10.3 in TS38.213.

In one option, for Scell dormancy indication without PDSCH, UE considers the multi-cell scheduling DCI scrambled with C-RNTI or MCS-C-RNTI as indicating Scell dormancy, not scheduling a PDSCH reception, only if the DCI is detected on Pcell and it indicates single cell, where the indicated single cell is Pcell and the corresponding bit field such as one-shot HARQ-ACK request field and FDRA bit field is with specific code point as defined in Clause 10.3 in TS38.213.

In one option, for dynamic TCI indication without PDSCH, UE considers the multi-cell scheduling DCI scrambled with CS-RNTI as indicating TCI, not scheduling a PDSCH reception, only if the DCI indicates single cell, and the corresponding bit field such as RV, MCS, NDI and FDRA bit field is with specific code point as defined in Clause 5.1.5 in TS38.214.

In one option, for type-3 codebook or HARQ-ACK retransmission, UE considers the multi-cell scheduling DCI scrambled with C-RNTI or MCS-C-RNTI as indicating type-3 codebook or HARQ-ACK retransmission, not scheduling a PDSCH reception, only if the DCI indicates single cell, and the corresponding bit field such as one-shot HARQ-ACK request field or HARQ-ACK retransmission indicator bit field and FDRA bit field is with specific code point as defined in Clause 9.1.4 or 9.1.5 in TS38.213.

In one or more embodiments, an NR system may facilitate multi-cell scheduling DCI without dynamic scheduled PDSCH or PUSCH, if the multi-cell scheduling indicates one or more cells.

In one embodiment, multi-cell scheduling DCI supports at least some cases as mentioned above, regardless the multi-cell scheduling indicates single or multiple cells. In one option, UE may expect the multi-cell scheduling DCI to indicate one or more than one cell for SPS PDSCH/CG PUSCH retransmission. UE performs SPS PDSCH/CG PUSCH retransmission in indicated cells, similar to dynamic scheduling cases for multi-cell scheduling. A multi-cell scheduling DCI can either schedule dynamic PDSCH/PUSCH for all indicated cells or SPS PDSCH/CG PUSCH retransmission for all indicated cells, but a multi-cell scheduling DCI cannot schedule a combination of dynamic PDSCH/PUSCH and SPS PDSCH/CG PUSCH at a time.

In one option, UE may expect the DCI scrambled with CS-RNTI to indicate one or more than one cell, and UE validates the DCI for activation or release by checking the corresponding bit field for the indicated cells, e.g., NDI/RV for each cell for activation, or NDI/MCS/FDRA for each cell for release.

In one example, if the validation for all the indicated cells is achieved, SPS PDSCH/CG PUSCH activation/release is applied to SPS PDSCH/CG PUSCH in the indicated cells, otherwise, validation fails for the DCI.

FIG. 1 illustrates one example of failed SPS release by a multi-cell scheduling DCI. In the example, a DCI scrambled with CS-RNTI indicates CC0 and CC1. The DCI includes separate bit field NDI and RV for CC0 and CC1, common bit field MCS and FDRA for CC0 and CC1. MCS indicates all ones, and FDRA indicates all zeros. For CC0, NDI=0, RV=0. For CC1, NDI=1, RV=2. Though the combination of {NDI1, RV1, MCS, FDRA} is aligned with specific code point for SPS release validation, the combination of {NDI2, RV2, MCS, FDRA} does not meet SPS release validation, thus the SPS release validation fails for both CC0 and CC1. UE does not perform any SPS release or reception.

In another example, if the validation for all the cells or the cells in a cell group in which at least one cell is indicated is achieved, SPS PDSCH/CG PUSCH activation/release is applied to SPS PDSCH/CG PUSCH in the indicated cells, otherwise, validation fails for the DCI (UE considers the PDCCH is not correctly decoded).

For example, in FIG. 1, assuming CC0 and CC1 belongs to different cell groups, UE assumes SPS release is achieved for CC0 and SPS release is not achieved for CC1. UE releases SPS in CC0. If CC0 and CC1 belongs to the same cell group, UE assumes the PDCCH is not correctly decoded, thus UE does not perform any SPS release or reception on CC0 or CC1.

In another example, if the validation for at least one of the indicated cells is achieved, SPS PDSCH/CG PUSCH activation/release is applied to SPS PDSCH/CG PUSCH in the indicated cell(s) with successful validation, while UE does not activate/release SPS PDSCH/CG PUSCH or retransmit SPS PDSCH/CG PUSCH in other indicated cell(s) without successful validation.

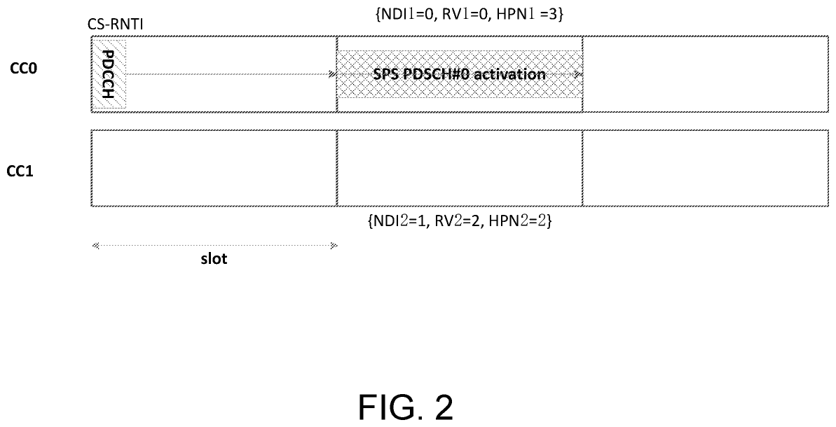

FIG. 2 illustrates one example of SPS activation by a multi-cell scheduling DCI. In the example, a DCI scrambled with CS-RNTI indicates CC0 and CC1. The DCI includes separate bit field NDI, RV, HPN for CC0 and CC1. For CC0, NDI=0, RV=0 and HPN=3. UE uses NDI and RV bit field to validate SPS activation for CC0, and the validation achieves. HPN bit field indicates the SPS configuration index. Therefore, UE receives the activated SPS PDSCH with SPS configuration index=3 on CC0. For CC1, NDI=1, RV=2 and HPN=2, the validation fails, thus UE does not perform any reception on CC1.

In another example, if the validation for at least one of the indicated cell groups is achieved, SPS PDSCH/CG PUSCH activation/release is applied to SPS PDSCH/CG PUSCH in the indicated cell group(s) with successful validation, while UE does not activate/release SPS PDSCH/CG PUSCH or retransmit SPS PDSCH/CG PUSCH in other indicated cell group(s) without successful validation. In another example, if the validation for at least one of the indicated cells is achieved, SPS PDSCH/CG PUSCH activation/release is applied to SPS PDSCH/CG PUSCH in the indicated cell(s) with successful validation, while UE assumes SPS PDSCH/CG PUSCH retransmission is scheduled for other indicated cells.

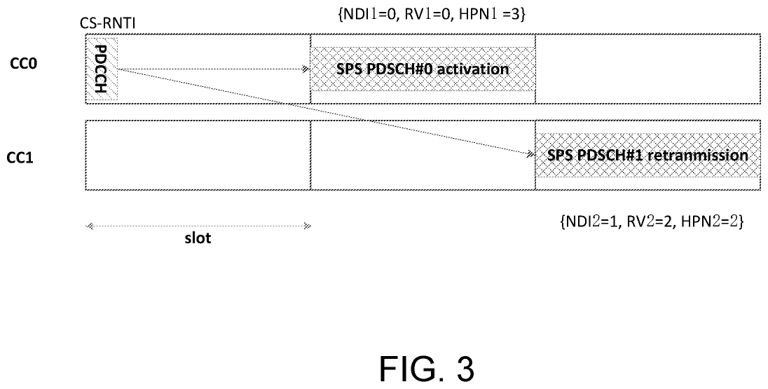

FIG. 3 illustrates one example of SPS activation and SPS retransmission by a multi-cell scheduling DCI. In the example, a DCI scrambled with CS-RNTI indicates CC0 and CC1. The DCI includes separate bit field NDI, RV, HPN for CC0 and CC1. The DCI is used to activate SPS PDSCH configuration 3 on CC0 and retransmit SPS PDSCH with HARQ process number 2 on CC1. UE validates SPS activation for CC0 and UE identifies SPS retransmission for CC1.

In another example, UE may assume SPS PDSCH/CG PUSCH activation is applied to SPS PDSCH/CG PUSCH in some of the indicated cell group(s) with successful validation, and SPS PDSCH/CG PUSCH release is applied to SPS PDSCH/CG PUSCH in other indicated cell group(s) with successful validation.

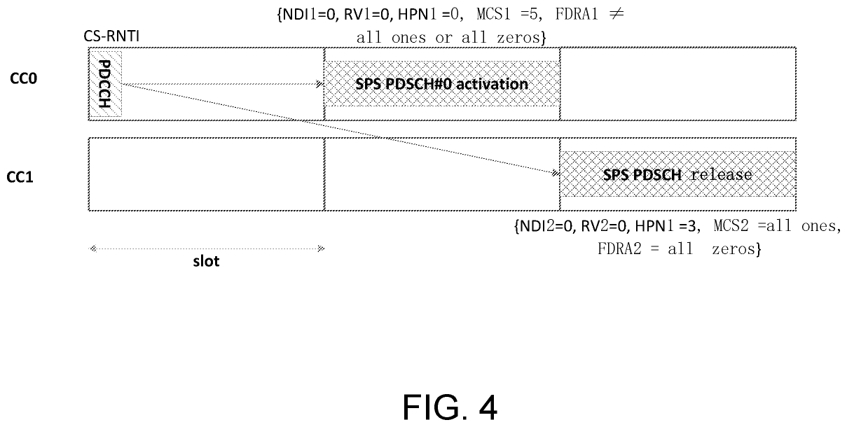

FIG. 4 illustrates one example of SPS activation and SPS release by a multi-cell scheduling DCI. In the example, a DCI scrambled with CS-RNTI indicates CC0 and CC1. The DCI includes separate bit field NDI, RV, HPN, MCS and FDRA for CC0 and CC1. The DCI is used to activate SPS PDSCH configuration 3 on CC0 and release SPS PDSCH with SPS PDSCH configuration 3 on CC1. UE validates SPS activation for CC0 and UE validates SPS release for CC1.

In another example, if the validation for at least one of the indicated cells is achieved, SPS PDSCH/CG PUSCH activation/release is applied to SPS PDSCH/CG PUSCH in the indicated cell(s) with successful validation, while UE assumes dynamic TCI indication is achieved, if the RV, MCS, NDI and FDRA bit field associated with other cells are with specific code point, if dynamic TCI indication is configured.

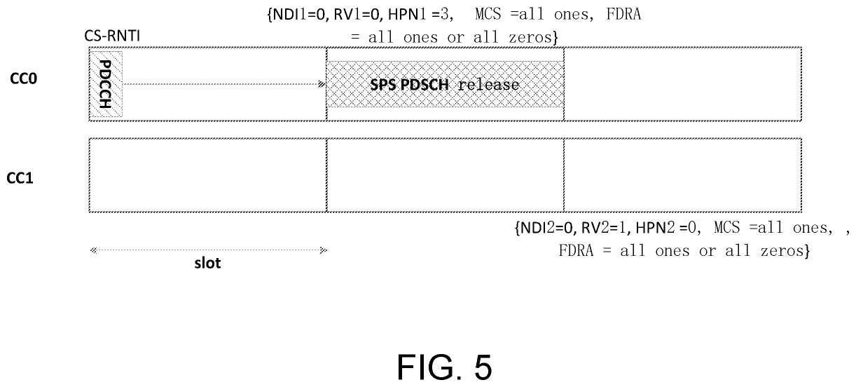

FIG. 5 illustrates one example of dynamic TCI indication and SPS release by a multi-cell scheduling DCI. In the example, a DCI scrambled with CS-RNTI indicates CC0 and CC1. The DCI includes separate bit field NDI, RV, HPN for CC0 and CC1 and common MCS and FDRA for CC0 and CC1. The DCI is used to release SPS PDSCH configuration 3 on CC0 and indicate dynamic TCI on CC1 (The indicated dynamic TCI can be applied to CC1 or both CC1 and CC0). UE validates SPS release for CC0 and UE validates dynamic TCI indication for CC1.

In one option, for SPS PDSCH/CG PUSCH activation by a multi-cell scheduling DCI, a row of SPS PDSCH/CG PUSCH configuration table for activation can indicate SPS PDSCH/CG PUSCH configurations to be activated that are in different cells, by configuring SPS PDSCH/CG PUSCH configuration index for each cell in the row of SPS PDSCH/CG PUSCH configuration table.

For this option, cell index for the SPS PDSCH/CG PUSCH configuration can be indicated separately in the scheduling DCI, e.g., in the carrier indicator field. Note that the number of SPS PDSCH/CG PUSCH configurations determined from the row of the of SPS PDSCH/CG PUSCH configuration table may have one to one mapping to the number of determined cells. In case when the number of SPS PDSCH/CG PUSCH configurations determined from the row of the SPS PDSCH/CG PUSCH configuration table is greater than the number of determined cells, only the first N_{Cell} SPS PDSCH/CG PUSCH configurations are valid in the row of the SPS PDSCH/CG PUSCH configuration table, where N_{Cell} is the number of determined cells.

In one example, in a row of SPS PDSCH/CG PUSCH configuration table, only single SPS PDSCH/CG PUSCH configuration index is provided for a cell. In another example, in a row of SPS PDSCH/CG PUSCH configuration table, one or more SPS PDSCH/CG PUSCH configuration indexes can be provided for a cell.

Table A illustrates one example of SPS PDSCH activation by multi-cell scheduling DCL The table includes 8 rows, where a set of SPS PDSCH configuration indexes are configured in each row, and a single SPS PDSCH configuration index is associated with a cell. Assuming a UE is configured with 3 cells for a multi-cell scheduling DCI. If the carrier indicator field indicates 1 cell, for an indicated row, only 1st elements of the row is applied to the indicated cell. If the carrier indicator field indicates 2 cells, for an indicated row, 1st elements of the row is applied to the 1^{st} indicated cell and 2^{nd} elements of the row is applied to the 2^{nd} indicated cell.

TABLE A
SPS PDSCH configuration table for SPS PDSCH
activation by a multi-cell scheduling DCI

| HPN | |
|---|---|
| indica- | |
| tion | |
| index | List of SPS PDSCH configuration index for a set of cells |
| 0 | {SPS PDSCH configuration index s1, SPS PDSCH configuration |
| | index s1, SPS PDSCH configuration index s1} |
| 1 | {SPS PDSCH configuration index s1, SPS PDSCH configuration |
| | index s2, SPS PDSCH configuration index s2} |
| 2 | {SPS PDSCH configuration index s1, SPS PDSCH configuration |
| | index s3, SPS PDSCH configuration index s3} |
| 3 | {SPS PDSCH configuration index s2, SPS PDSCH configuration |
| | index s1, SPS PDSCH configuration index s1} |
| 4 | {SPS PDSCH configuration index s2, SPS PDSCH configuration |
| | index s1, SPS PDSCH configuration index s2} |
| 5 | {SPS PDSCH configuration index s2, SPS PDSCH configuration |
| | index s1, SPS PDSCH configuration index s3} |
| 6 | {SPS PDSCH configuration index s3, SPS PDSCH configuration |
| | index s1, SPS PDSCH configuration index s2} |
| 7 | {SPS PDSCH configuration index s3, SPS PDSCH configuration |
| | index s3, SPS PDSCH configuration index s3} |

In one option, for SPS PDSCH/CG PUSCH activation by a multi-cell scheduling DCI, a single SPS PDSCH/CG PUSCH configuration index bit field (HPN bit field) is commonly applied for all the scheduled cells indicated in the DCI or the cells in a cell group. If a multi-cell scheduling DCI includes a separate HPN bit field for each cell group, then, the same SPS PDSCH/CG PUSCH configuration index is commonly applied for all cells associated with a cell group, while different SPS PDSCH/CG PUSCH configuration index can be applied for different cells associated with a different cell group. If a multi-cell scheduling DCI includes separate HPN bit field for each cell, then, a different SPS PDSCH/CG PUSCH configuration index can be applied for different cells.

For this option, if the number of configurations for a serving cell c is different for different cells, and the value of the configure index bit field is larger than the number of configurations for a serving cell c, the activated configuration index for serving cell c is determined by mod (indicated configuration index value, the number of configurations for serving cell c). Alternatively, the SPS PDSCH/CG PUSCH on serving cell c is not activated, even though the indicated set of cells includes the serving cell c. Alternatively, a pre-defined SPS PDSCH/CG PUSCH configuration index is applied for the serving cell c.

In one option, for SPS PDSCH/CG PUSCH release by a multi-cell scheduling DCI, a row of SPS PDSCH/CG PUSCH configuration table for release can indicate SPS PDSCH/CG PUSCH configurations to be released that are in different cells, by configuring SPS PDSCH/CG PUSCH configuration index for each cell in the row of SPS PDSCH/CG PUSCH configuration table.

For this option, cell index for the SPS PDSCH/CG PUSCH configuration can be indicated separately in the scheduling DCI, e.g., in the carrier indicator field. Note that the number of SPS PDSCH/CG PUSCH configuration determined from the row of the of SPS PDSCH/CG PUSCH configuration table may have one to one mapping to the number of determined cells. In case when the number of SPS PDSCH/CG PUSCH configurations determined from the row of the SPS PDSCH/CG PUSCH configuration table is greater than the number of determined cells, only the first N_{Cell} SPS PDSCH/CG PUSCH configurations are valid in the row of the SPS PDSCH/CG PUSCH configuration table, where N_{Cell} is the number of determined cells.

In one example, in a row of SPS PDSCH/CG PUSCH configuration table, only single SPS PDSCH/CG PUSCH configuration index is provided for a cell. In another example, in a row of SPS PDSCH/CG PUSCH configuration table, one or more SPS PDSCH/CG PUSCH configuration indexes can be provided for a cell. With this example, a row of SPS PDSCH/CG PUSCH configuration table for release can indicate multiple sets of SPS PDSCH/CG PUSCH configuration indexes that are in different cells. Table B illustrates one example of SPS PDSCH configuration table for SPS PDSCH release by a multi-cell scheduling DCI. In the example, row with HPN index 0 supports SPS release for 2 SPS configurations s1&s2 for the 2nd indicated cell. Alternatively, a row of SPS PDSCH/CG PUSCH configuration table for release can indicate SPS PDSCH/CG PUSCH configuration indexes that are in different cells, by configuring a set of row index from the SPS PDSCH/CG PUSCH configuration table for release of the scheduled cell for each cell in a row. This option can help reduce the signaling overhead for the SPS PDSCH/CG PUSCH release by a multi-cell scheduling DCI.

TABLE B
SPS PDSCH configuration table for SPS PDSCH
release by a multi-cell scheduling DCI

| HPN indication | |
|---|---|
| index | List of SPS PDSCH configuration index for a set of cells |
| 0 | {SPS PDSCH configuration index s1 for a 1^{st} cell, SPS PDSCH |
| | configuration index s1& s2 for a 2^{nd} cell, SPS PDSCH configuration |
| | index s1 for a 3^{rd} cell} |
| 1 | {SPS PDSCH configuration index s1 &s2&s7 for a 1^{st} cell, SPS |
| | PDSCH configuration index s2 for a 2^{nd} cell, SPS PDSCH |
| | configuration index s2 for a 3^{rd} cell} |
| 2 | {SPS PDSCH configuration index s1 &s2 for a 1^{st} cell, SPS PDSCH |
| | configuration index s3 &s5 for a 2^{nd} cell, SPS PDSCH configuration |
| | index s3 for a 3^{rd} cell} |
| 3 | {SPS PDSCH configuration index s2 for a 1^{st} cell, SPS PDSCH |
| | configuration index s1 for a 2^{nd} cell, SPS PDSCH configuration index |
| | s1&s2 for a 3^{rd} cell} |
| 4 | {SPS PDSCH configuration index s2 for a 1^{st} cell, SPS PDSCH |
| | configuration index s1 for a 2^{nd} cell, SPS PDSCH configuration index |
| | s2 for a 3^{rd} cell} |
| 5 | {SPS PDSCH configuration index s2&s3&s4&s5 for a 1^{st} cell, SPS |
| | PDSCH configuration index s1 for a 2^{nd} cell, SPS PDSCH |
| | configuration index s3 for a 3^{rd} cell} |
| 6 | {SPS PDSCH configuration index s3 for a 1^{st} cell, SPS PDSCH |
| | configuration index s1&s2&s3&s4&s5 for a 2^{nd} cell, SPS PDSCH |
| | configuration index s1&s2&s3 for a 3^{rd} cell} |
| 7 | {SPS PDSCH configuration index s3 for a 1^{st} cell, SPS PDSCH |
| | configuration index s3 for a 2^{nd} cell, SPS PDSCH configuration index |
| | s3 for a 3^{rd} cell} |

In one option, for Scell dormancy indication without PDSCH, UE considers the multi-cell scheduling DCI scrambled with C-RNTI or MCS-C-RNTI as indicating Scell dormancy, not scheduling a PDSCH reception, if one-shot HARQ-ACK request field and FDRA is with specific code point, regardless of single or multiple cells is indicated.

In one option, for Scell dormancy indication without PDSCH, UE considers the multi-cell scheduling DCI scrambled with C-RNTI or MCS-C-RNTI as indicating Scell dormancy, not scheduling a PDSCH reception, if the DCI is detected on Pcell, one-shot HARQ-ACK request field and FDRA is with specific code point, regardless of single or multiple cells is indicated.

In one or more embodiments, for both options, if multiple cells are indicated, UE checks the one-shot HARQ-ACK request field and FDRA bit field for the indicated cells. In one example, UE expects one-shot HARQ-ACK request field and FDRA bit field for all the indicated cells are with specific code point so that the DCI is considered as indicating Scell dormancy, otherwise, the DCI is discarded. In another example, UE may expect a multi-cell DCI to indicate Scell dormancy as well as scheduling PDSCH for some of the indicated cells. For example, a multi-cell DCI includes separate FDRA bit field for two cell groups. gNB may set one-shot HARQ-ACK request field as ‘0’, first FDRA bit field as all ones and second FDRA bit field with a value other than all ones or all zeros. Then, if gNB indicates multiple cells with some cells associated with 1st FDRA bit field and some cells associated with 2nd FDRA bit field, UE can assume Scell dormancy is indicated and PDSCH is scheduled for cells associated with 2nd FDRA bit field.

In one option, for dynamic TCI indication without PDSCH, UE considers the multi-cell scheduling DCI scrambled with CS-RNTI as indicating TCI, not scheduling a PDSCH reception, if the corresponding bit field such as RV, MCS, NDI and FDRA bit field is with specific code point, regardless of single or multiple cells is indicated.

If multiple cells are indicated, UE checks RV, MCS, NDI and FDRA bit field for the indicated cells. In one example, UE expects these bits field for all the indicated cells are with specific code point so that the DCI is considered as Dynamic TCI indication, otherwise, the DCI is discarded. In another example, UE may expect a multi-cell DCI to indicate Dynamic TCI indication as well as SPS PDSCH activation/release/retransmission for some of the indicated cells. For example, a multi-cell DCI includes separate FDRA bit field for two cell groups. gNB may transmit the DCI scrambled with CS-RNTI, set first set of RV, MCS, NDI and FDRA bit field to specific code point for dynamic TCI indication and second set of RV, MCS, NDI and FDRA bit field for SPS activation/release/retransmission.

In one option, for type-3 codebook or HARQ-ACK retransmission, UE considers the multi-cell scheduling DCI scrambled with C-RNTI as indicating type-3 codebook or HARQ-ACK retransmission, not scheduling a PDSCH reception, if the corresponding bit field such as HARQ-ACK request bit field and FDRA bit field is with specific code point, regardless of single or multiple cells is indicated.

If multiple cells are indicated, UE checks HARQ-ACK request bit field and FDRA bit field for the indicated cells. In one example, UE expects these bits field for all the indicated cells are with specific code point so that the DCI is considered as type-3 codebook or HARQ-ACK retransmission, otherwise, the DCI is discarded. In another example, UE may expect a multi-cell DCI to indicate type-3 codebook or HARQ-ACK retransmission as well as dynamic PDSCH or PUSCH scheduling for some of the indicated cells. For example, a multi-cell DCI includes separate FDRA bit field for two cell groups. gNB may transmit the DCI scrambled with C-RNTI, set first set of FDRA bit field with all ‘0’s or all ‘1’s for type-3 codebook or HARQ-ACK retransmission and second set of FDRA bit field with non-zeros or non-all-ones value for dynamic PDSCH scheduling for corresponding cells.

In one embodiment, multi-cell scheduling DCI does not support the case without dynamic PDSCH scheduling. For example, UE does not expect a multi-cell scheduling DCI is scrambled with CS-RNTI.

In one or more embodiments, an NR system may facilitate HARQ-ACK for multi-cell scheduling DCI without dynamic scheduled PDSCH.

In one embodiment, if a multi-cell scheduling DCI activates SPS PDSCHs, HARQ-ACK of all the activated SPS PDSCHs are to be reported in the same PUCCH.

In one embodiment, if a multi-cell scheduling DCI releases SPS PDSCHs, for type-1 HARQ-ACK codebook, the HARQ-ACK of the DCI is in HARQ-ACK bit location for the serving cell with lowest cell index. The serving cell is one of the scheduled cells to release SPS PDSCHs. If there is more than one SPS configuration to be released on the serving cell, HARQ-ACK bit location for the serving cell is the HARQ-ACK bit location for the SPS configuration with lowest index for the serving cell.

In one embodiment, if a multi-cell scheduling DCI indicates dynamic TCI indication without PDSCH, for type-1 HARQ-ACK codebook, the HARQ-ACK of the DCT is in HARQ-ACK bit location for one of the indicated serving cells and the virtual PDSCH indicated by TDRA field for the one of indicated serving cells. The one of indicated serving cells can be the serving cell with lowest serving cell index.

In one embodiment, if a multi-cell scheduling DCI indicates dynamic TCI indication and SPS PDSCH activation/release/retransmission at least for some of the indicated cells, UE does not transmit HARQ-ACK bit for dynamic TCI indication in addition to HARQ-ACK for SPS PDSCH. Alternatively, UE transmits HARQ-ACK bit for dynamic TCI indication and HARQ-ACK for SPS PDSCH, if type-2 HARQ-ACK codebook is configured. Alternatively, UE transmits HARQ-ACK bit for dynamic TCI indication and HARQ-ACK for SPS PDSCH, if type-1 HARQ-ACK codebook is configured. Alternatively, UE transmits HARQ-ACK bit for dynamic TCI indication and HARQ-ACK for SPS PDSCH respectively in HARQ-ACK codebook. For example, for type-1 HARQ-ACK codebook, UE transmits HARQ-ACK for dynamic TCI indication based on a virtual PDSCH indicated by the TDRA bit field for one or all cells of the cell group associated with the RV, MCS, NDI and FDRA bit field for dynamic TCI indication validation, and HARQ-ACK for SPS PDSCH activation/release/retransmission according to bit location for corresponding SPS PDSCHs.

With this embodiment, different options can be applied for SPS PDSCH activation/retransmission and SPS PDSCH release. For example, if a multi-cell scheduling DCI indicates dynamic TCI indication and SPS PDSCH activation, UE transmits HARQ-ACK bit for dynamic TCI indication and HARQ-ACK for SPS PDSCH. If a multi-cell scheduling DCI indicates dynamic TCI indication and SPS PDSCH activation, UE does not transmit HARQ-ACK bit for dynamic TI indication in addition to HARQ-ACK for SPS PDSCH release.

In one embodiment, if a multi-cell scheduling DCI indicates Scell dormancy and schedules dynamic PDSCH at least for some of the indicated cells, UE does not transmit HARQ-ACK bit for Scell dormancy in addition to HARQ-ACK for dynamic PDSCH. Alternatively, UE transmits HARQ-ACK bit for dynamic TCI indication and HARQ-ACK for SPS PDSCH, if type-2 HARQ-ACK codebook is configured.

In one or more embodiments, a wireless communication system may have a user equipment (UE) receiving the configuration of a search space set for a Downlink Control Information (DCI) format meant for multi-cell scheduling. The UE may detect the DCI format. In some instances, the DCI format may activate an SPS PDSCH or a CG PUSCH or schedule retransmissions for an SPS PDSCH or a CG PUSCH if the DCI is scrambled with CS-RNTI and the corresponding bit fields in the DCI are validated. It should be understood that DCI is the broader concept of control information transmitted from the network to the UE, while DCI format refers to the structured representation and organization of that control information in binary form for efficient communication between the network and the user equipment.

DCI is information sent by the network to the user equipment (UE) to control the downlink (data sent from the network to the UE). The format specifies how the information is structured and what actions the UE should take based on this information. Search space set refers to a predefined set of resources that the UE uses to search for specific control information in the downlink. It helps the UE find the DCI sent by the network. A search space set refers to a group of search spaces in which the UE should look for DCI. This set could be defined by the network based on various factors such as the capabilities of the UE, the current network conditions, the specific communication needs, etc. In other words, the search space set dictates where within a given transmission frame a UE should be searching for DCI, which in turn, instructs the UE on how to operate for subsequent transmissions or receptions.

The DCI is encrypted or scrambled with a specific identifier (CS-RNTI) to make it secure and uniquely addressable to a particular UE. The DCI contains various bits (binary digits) that carry specific information, and these bits need to be correctly validated by the UE to ensure the data is interpreted correctly.

A DCI format carries scheduling information in wireless communication systems like LTE or 5G NR. For instance, it may instruct a UE device on how to transmit or receive data, specifying parameters like frequency, time, power level, etc.

In other scenarios, the DCI may indicate Scell dormancy, or a TCI update, or HARQ-ACK codebook transmission/retransmission without scheduling a PDSCH if the DCI is scrambled with a certain RNTI and the corresponding bit fields in the DCI are validated. In these instances, the UE may not expect the DCI to indicate more than one serving cell. However, in other instances, the UE may expect the DCI to indicate more than one serving cell.

For scenarios where the DCI is scrambled with CS-RNTI to indicate one or multiple cells, the UE may validate the DCI for activation or release by checking the corresponding bit field for the indicated cells. In cases where the DCI activates SPS PDSCH or CG PUSCH with multi-cell scheduling, a row of SPS PDSCH/CG PUSCH configuration table for activation may indicate SPS PDSCH/CG PUSCH configurations to be activated in different cells, by configuring an SPS PDSCH/CG PUSCH configuration index for each cell in the row of the SPS PDSCH/CG PUSCH configuration table.

Alternatively, if the DCI activates SPS PDSCH or CG PUSCH with multi-cell scheduling, a single SPS PDSCH/CG PUSCH configuration index bit field may be commonly applied for all the scheduled cells indicated in the DCI or the cells in a cell group. If the DCI releases SPS PDSCH or CG PUSCH with multi-cell scheduling, a row of SPS PDSCH/CG PUSCH configuration table for release may indicate SPS PDSCH/CG PUSCH configurations to be released that are in different cells, by configuring an SPS PDSCH/CG PUSCH configuration index for each cell in the row of the SPS PDSCH/CG PUSCH configuration table.

In scenarios where the DCI activates multiple SPS PDSCHs, the UE may report HARQ-ACK of all the activated SPS PDSCHs in the same Physical Uplink Control Channel (PUCCH). For a type-1 HARQ-ACK codebook, if the DCI releases SPS PDSCHs in multiple serving cells, the HARQ-ACK of the DCI may be in HARQ-ACK bit location for the serving cell with the lowest cell index.

In instances where the DCI indicates dynamic Transmission Configuration Indicator (TCI) without PDSCH, the HARQ-ACK of the DCI may be in HARQ-ACK bit location for one of the indicated serving cells and the virtual PDSCH indicated by TDRA field for one of the indicated serving cells. If the DCI indicates Scell dormancy and schedules dynamic PDSCH for some of the indicated cells, the UE may not transmit HARQ-ACK bit for Scell dormancy in addition to HARQ-ACK for dynamic PDSCH. However, if a type-2 HARQ-ACK codebook is configured and the DCI indicates Scell dormancy and schedules dynamic PDSCH for some of the indicated cells, the UE may transmit HARQ-ACK bit for dynamic TCI indication and HARQ-ACK for SPS PDSCH.

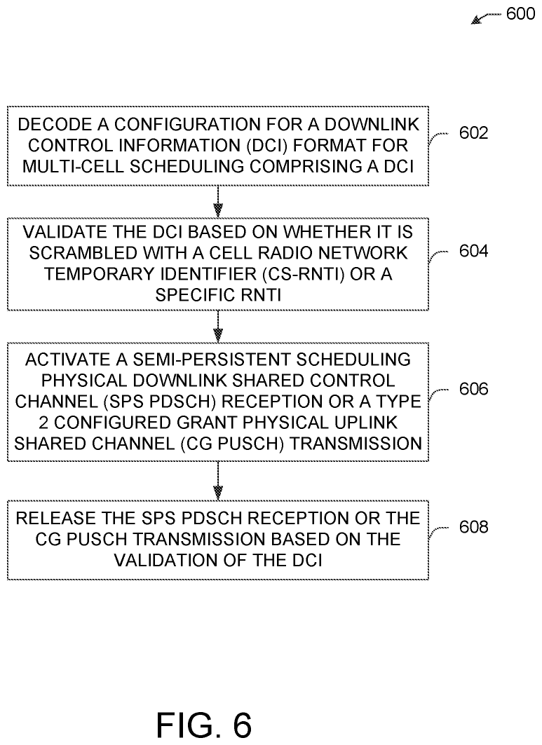

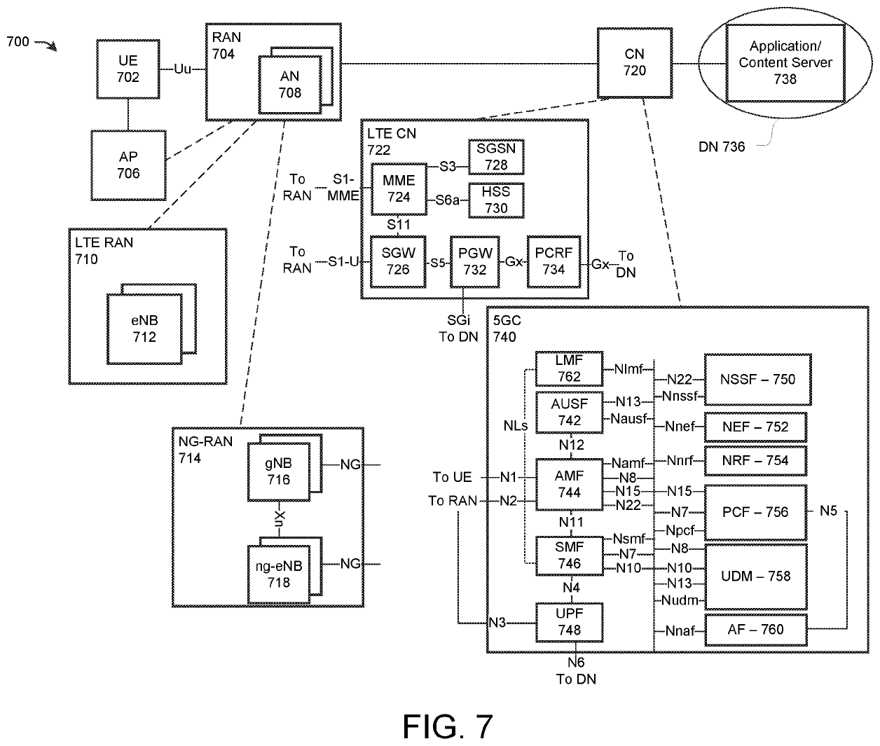

In some embodiments, the electronic device(s), network(s), system(s), chip(s) or component(s), or portions or implementations thereof, of FIGS. 7-9, or some other figure herein, may be configured to perform one or more processes, techniques, or methods as described herein or portions thereof. One such process is depicted in FIG. 6.

For example, the process may include, at 602, decoding a configuration for a Downlink Control Information (DCI) format for multi-cell scheduling.

The process further includes, at 604, validating the DCI based on whether it is scrambled with a CS-RNTI or a specific RNTI.

The process further includes, at 606, activating a semi-persistent scheduling physical downlink shared control channel (SPS PDSCH) reception or a Type 2 configured grant physical uplink shared channel (CG PUSCH) transmission.

The process further includes, at 608, releasing the SPS PDSCH reception or the CG PUSCH transmission based on the validation of the DCI.

The device may include processing circuitry that is further configured to determine whether the DCI may indicate Scell dormancy, a TCI update, or HARQ-ACK codebook transmission/retransmission without necessarily scheduling a PDSCH.

The device may also include processing circuitry that, if the DCI is scrambled with RNTI and a corresponding bit field in the DCI is validated, the DCI may indicate Scell dormancy, or TCI update, or HARQ-ACK codebook transmission/retransmission without necessarily scheduling a PDSCH. Moreover, the device may include processing circuitry that, based on the DCI, may indicate no more than one serving cell. Furthermore, the device may have processing circuitry that, when the DCI is scrambled with CS-RNTI and validates the DCI for activation or release by checking the corresponding bit field for the indicated cells, the DCI may indicate one or more cells.

Additionally, the device may include processing circuitry that is further configured to apply a single SPS PDSCH or CG PUSCH configuration index bit field commonly for all scheduled cells indicated in the DCI or the cells in a cell group when the DCI activates SPS PDSCH or CG PUSCH with multi-cell scheduling. Likewise, the device may have processing circuitry that is further configured to report HARQ-ACK of all activated SPS PDSCHs in the same Physical Uplink Control Channel (PUCCH) when the DCI activates multiple SPS PDSCHs in multiple serving cells. Furthermore, the device may include processing circuitry that is further configured to report HARQ-ACK of the DCI in HARQ-ACK bit location for a serving cell with the lowest cell index when the DCI releases SPS PDSCHs in multiple serving cells for a type-1 HARQ-ACK codebook. Moreover, the device may have processing circuitry that is further configured to transmit HARQ-ACK bit for dynamic TCI indication and HARQ-ACK for SPS PDSCH if a type-2 HARQ-ACK codebook is configured and the DCI indicates Scell dormancy and schedules dynamic PDSCH for one or more indicated cells.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

It is understood that the above descriptions are for purposes of illustration and are not meant to be limiting.

FIGS. 7-9 illustrate various systems, devices, and components that may implement aspects of disclosed embodiments.

FIG. 7 illustrates an example network architecture 700 according to various embodiments. The network 700 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 700 includes a UE 702, which is any mobile or non-mobile computing device designed to communicate with a RAN 704 via an over-the-air connection. The UE 702 is communicatively coupled with the RAN 704 by a Uu interface, which may be applicable to both LTE and NR systems. Examples of the UE 702 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, and/or the like. The network 700 may include a plurality of UEs 702 coupled directly with one another via a D2D, ProSe, PC5, and/or sidelink (SL) interface. These UEs 702 may be M2M/D2D/MTC/IoT devices and/or vehicular systems that communicate using physical sidelink channels such as, but not limited to, PSBCH, PSDCH, PSSCH, PSCCH, PSFCH, etc. The UE 702 may perform blind decoding attempts of SL channels/links according to the various embodiments herein.

In some embodiments, the UE 702 may additionally communicate with an AP 706 via an over-the-air (OTA) connection. The AP 706 manages a WLAN connection, which may serve to offload some/all network traffic from the RAN 704. The connection between the UE 702 and the AP 706 may be consistent with any IEEE 802.11 protocol. Additionally, the UE 702, RAN 704, and AP 706 may utilize cellular-WLAN aggregation/integration (e.g., LWA/LWIP). Cellular-WLAN aggregation may involve the UE 702 being configured by the RAN 704 to utilize both cellular radio resources and WLAN resources.

The RAN 704 includes one or more access network nodes (ANs) 708. The ANs 708 terminate air-interface(s) for the UE 702 by providing access stratum protocols including RRC, PDCP, RLC, MAC, and PHY/L1 protocols. In this manner, the AN 708 enables data/voice connectivity between CN 720 and the UE 702. The ANs 708 may be a macrocell base station or a low power base station for providing femtocells, picocells or other like cells having smaller coverage areas, smaller user capacity, or higher bandwidth compared to macrocells; or some combination thereof. In these implementations, an AN 708 be referred to as a BS, gNB, RAN node, eNB, ng-eNB, NodeB, RSU, TRxP, etc.

One example implementation is a “CU/DU split” architecture where the ANs 708 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like) (see e.g., 3GPP TS 38.401 v 16.1.0 (2020 March)). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 708 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The plurality of ANs may be coupled with one another via an X2 interface (if the RAN 704 is an LTE RAN or Evolved Universal Terrestrial Radio Access Network (E-UTRAN) 710) or an Xn interface (if the RAN 704 is a NG-RAN 714). The X2/Xn interfaces, which may be separated into control/user plane interfaces in some embodiments, may allow the ANs to communicate information related to handovers, data/context transfers, mobility, load management, interference coordination, etc.

The ANs of the RAN 704 may each manage one or more cells, cell groups, component carriers, etc. to provide the UE 702 with an air interface for network access. The UE 702 may be simultaneously connected with a plurality of cells provided by the same or different ANs 708 of the RAN 704. For example, the UE 702 and RAN 704 may use carrier aggregation to allow the UE 702 to connect with a plurality of component carriers, each corresponding to a Pcell or Scell. In dual connectivity scenarios, a first AN 708 may be a master node that provides an MCG and a second AN 708 may be secondary node that provides an SCG. The first/second ANs 708 may be any combination of eNB, gNB, ng-eNB, etc.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 702 or AN 708 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 704 may be an E-UTRAN 710 with one or more eNBs 712. The an E-UTRAN 710 provides an LTE air interface (Uu) with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 704 may be an next generation (NG)-RAN 714 with one or more gNB 716 and/or on or more ng-eNB 718. The gNB 716 connects with 5G-enabled UEs 702 using a 5G NR interface. The gNB 716 connects with a 5GC 740 through an NG interface, which includes an N2 interface or an N3 interface. The ng-eNB 718 also connects with the 5GC 740 through an NG interface, but may connect with a UE 702 via the Uu interface. The gNB 716 and the ng-eNB 718 may connect with each other over an Xn interface.

In some embodiments, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an AMF 744 (e.g., N2 interface).

The NG-RAN 714 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (e.g., PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

The RAN 704 is communicatively coupled to CN 720 that includes network elements and/or network functions (NFs) to provide various functions to support data and telecommunications services to customers/subscribers (e.g., UE 702). The components of the CN 720 may be implemented in one physical node or separate physical nodes. In some embodiments, NFV may be utilized to virtualize any or all of the functions provided by the network elements of the CN 720 onto physical compute/storage resources in servers, switches, etc. A logical instantiation of the CN 720 may be referred to as a network slice, and a logical instantiation of a portion of the CN 720 may be referred to as a network sub-slice.

The CN 720 may be an LTE CN 722 (also referred to as an Evolved Packet Core (EPC) 722). The EPC 722 may include MME 724, SGW 726, SGSN 728, HSS 730, PGW 732, and PCRF 734 coupled with one another over interfaces (or “reference points”) as shown. The NFs in the EPC 722 are briefly introduced as follows.

The MME 724 implements mobility management functions to track a current location of the UE 702 to facilitate paging, bearer activation/deactivation, handovers, gateway selection, authentication, etc.

The SGW 726 terminates an S1 interface toward the RAN 710 and routes data packets between the RAN 710 and the EPC 722. The SGW 726 may be a local mobility anchor point for inter-RAN node handovers and also may provide an anchor for inter-3GPP mobility. Other responsibilities may include lawful intercept, charging, and some policy enforcement.

The SGSN 728 tracks a location of the UE 702 and performs security functions and access control. The SGSN 728 also performs inter-EPC node signaling for mobility between different RAT networks; PDN and S-GW selection as specified by MME 724; MME 724 selection for handovers; etc. The S3 reference point between the MME 724 and the SGSN 728 enable user and bearer information exchange for inter-3GPP access network mobility in idle/active states.

The HSS 730 includes a database for network users, including subscription-related information to support the network entities' handling of communication sessions. The HSS 730 can provide support for routing/roaming, authentication, authorization, naming/addressing resolution, location dependencies, etc. An S6a reference point between the HSS 730 and the MME 724 may enable transfer of subscription and authentication data for authenticating/authorizing user access to the EPC 720.

The PGW 732 may terminate an SGi interface toward a data network (DN) 736 that may include an application (app)/content server 738. The PGW 732 routes data packets between the EPC 722 and the data network 736. The PGW 732 is communicatively coupled with the SGW 726 by an S5 reference point to facilitate user plane tunneling and tunnel management. The PGW 732 may further include a node for policy enforcement and charging data collection (e.g., PCEF). Additionally, the SGi reference point may communicatively couple the PGW 732 with the same or different data network 736. The PGW 732 may be communicatively coupled with a PCRF 734 via a Gx reference point.

The PCRF 734 is the policy and charging control element of the EPC 722. The PCRF 734 is communicatively coupled to the app/content server 738 to determine appropriate QoS and charging parameters for service flows. The PCRF 732 also provisions associated rules into a PCEF (via Gx reference point) with appropriate TFT and QCI.

The CN 720 may be a 5GC 740 including an AUSF 742, AMF 744, SMF 746, UPF 748, NSSF 750, NEF 752, NRF 754, PCF 756, UDM 758. and AF 760 coupled with one another over various interfaces as shown. The NFs in the 5GC 740 are briefly introduced as follows.

The AUSF 742 stores data for authentication of UE 702 and handle authentication-related functionality. The AUSF 742 may facilitate a common authentication framework for various access types.

The AMF 744 allows other functions of the 5GC 740 to communicate with the UE 702 and the RAN 704 and to subscribe to notifications about mobility events with respect to the UE 702. The AMF 744 is also responsible for registration management (e.g., for registering UE 702), connection management, reachability management, mobility management, lawful interception of AMF-related events, and access authentication and authorization. The AMF 744 provides transport for SM messages between the UE 702 and the SMF 746, and acts as a transparent proxy for routing SM messages. AMF 744 also provides transport for SMS messages between UE 702 and an SMSF. AMF 744 interacts with the AUSF 742 and the UE 702 to perform various security anchor and context management functions. Furthermore, AMF 744 is a termination point of a RAN-CP interface, which includes the N2 reference point between the RAN 704 and the AMF 744. The AMF 744 is also a termination point of NAS (N1) signaling, and performs NAS ciphering and integrity protection.

AMF 744 also supports NAS signaling with the UE 702 over an N3IWF interface. The N3IWF provides access to untrusted entities. N3IWF may be a termination point for the N2 interface between the (R)AN 704 and the AMF 744 for the control plane, and may be a termination point for the N3 reference point between the (R)AN 714 and the 748 for the user plane. As such, the AMF 744 handles N2 signalling from the SMF 746 and the AMF 744 for PDU sessions and QoS, encapsulate/de-encapsulate packets for IPSec and N3 tunnelling, marks N3 user-plane packets in the uplink, and enforces QoS corresponding to N3 packet marking taking into account QoS requirements associated with such marking received over N2. N3IWF may also relay UL and DL control-plane NAS signalling between the UE 702 and AMF 744 via an N1 reference point between the UE 702 and the AMF 744, and relay uplink and downlink user-plane packets between the UE 702 and UPF 748. The N3IWF also provides mechanisms for IPsec tunnel establishment with the UE 702. The AMF 744 may exhibit an Namf service-based interface, and may be a termination point for an N14 reference point between two AMFs 744 and an N17 reference point between the AMF 744 and a 5G-EIR (not shown by FIG. 7).

The SMF 746 is responsible for SM (e.g., session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 744 over N2 to AN 708; and determining SSC mode of a session. SM refers to management of a PDU session, and a PDU session or “session” refers to a PDU connectivity service that provides or enables the exchange of PDUs between the UE 702 and the DN 736.

The UPF 748 acts as an anchor point for intra-RAT and inter-RAT mobility, an external PDU session point of interconnect to data network 736, and a branching point to support multi-homed PDU session. The UPF 748 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 748 may include an uplink classifier to support routing traffic flows to a data network.

The NSSF 750 selects a set of network slice instances serving the UE 702. The NSSF 750 also determines allowed NSSAI and the mapping to the subscribed S-NSSAIs, if needed. The NSSF 750 also determines an AMF set to be used to serve the UE 702, or a list of candidate AMFs 744 based on a suitable configuration and possibly by querying the NRF 754. The selection of a set of network slice instances for the UE 702 may be triggered by the AMF 744 with which the UE 702 is registered by interacting with the NSSF 750; this may lead to a change of AMF 744. The NSSF 750 interacts with the AMF 744 via an N22 reference point; and may communicate with another NSSF in a visited network via an N31 reference point (not shown).

The NEF 752 securely exposes services and capabilities provided by 3GPP NFs for third party, internal exposure/re-exposure, AFs 760, edge computing or fog computing systems (e.g., edge compute node, etc. In such embodiments, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics.

The NRF 754 supports service discovery functions, receives NF discovery requests from NF instances, and provides information of the discovered NF instances to the requesting NF instances. NRF 754 also maintains information of available NF instances and their supported services. The NRF 754 also supports service discovery functions, wherein the NRF 754 receives NF Discovery Request from NF instance or an SCP (not shown), and provides information of the discovered NF instances to the NF instance or SCP.

The PCF 756 provides policy rules to control plane functions to enforce them, and may also support unified policy framework to govern network behavior. The PCF 756 may also implement a front end to access subscription information relevant for policy decisions in a UDR of the UDM 758. In addition to communicating with functions over reference points as shown, the PCF 756 exhibit an Npcf service-based interface.

The UDM 758 handles subscription-related information to support the network entities' handling of communication sessions, and stores subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR 221 to allow the UDM 758, PCF 756, and NEF 752 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

AF 760 provides application influence on traffic routing, provide access to NEF 752, and interact with the policy framework for policy control. The AF 760 may influence UPF 748 (re)selection and traffic routing. Based on operator deployment, when AF 760 is considered to be a trusted entity, the network operator may permit AF 760 to interact directly with relevant NFs. Additionally, the AF 760 may be used for edge computing implementations,

The 5GC 740 may enable edge computing by selecting operator/3rd party services to be geographically close to a point that the UE 702 is attached to the network. This may reduce latency and load on the network. In edge computing implementations, the 5GC 740 may select a UPF 748 close to the UE 702 and execute traffic steering from the UPF 748 to DN 736 via the N6 interface. This may be based on the UE subscription data, UE location, and information provided by the AF 760, which allows the AF 760 to influence UPF (re)selection and traffic routing.

The data network (DN) 736 may represent various network operator services, Internet access, or third party services that may be provided by one or more servers including, for example, application (app)/content server 738. The DN 736 may be an operator external public, a private PDN, or an intra-operator packet data network, for example, for provision of IMS services. In this embodiment, the app server 738 can be coupled to an IMS via an S-CSCF or the I-CSCF. In some implementations, the DN 736 may represent one or more local area DNs (LADNs), which are DNs 736 (or DN names (DNNs)) that is/are accessible by a UE 702 in one or more specific areas. Outside of these specific areas, the UE 702 is not able to access the LADN/DN 736.

Additionally or alternatively, the DN 736 may be an Edge DN 736, which is a (local) Data Network that supports the architecture for enabling edge applications. In these embodiments, the app server 738 may represent the physical hardware systems/devices providing app server functionality and/or the application software resident in the cloud or at an edge compute node that performs server function(s). In some embodiments, the app/content server 738 provides an edge hosting environment that provides support required for Edge Application Server's execution.

In some embodiments, the 5GS can use one or more edge compute nodes to provide an interface and offload processing of wireless communication traffic. In these embodiments, the edge compute nodes may be included in, or co-located with one or more RAN 710, 714. For example, the edge compute nodes can provide a connection between the RAN 714 and UPF 748 in the 5GC 740. The edge compute nodes can use one or more NFV instances instantiated on virtualization infrastructure within the edge compute nodes to process wireless connections to and from the RAN 714 and UPF 748.

The interfaces of the 5GC 740 include reference points and service-based interfaces. The reference points include: N1 (between the UE 702 and the AMF 744), N2 (between RAN 714 and AMF 744), N3 (between RAN 714 and UPF 748), N4 (between the SMF 746 and UPF 748), N5 (between PCF 756 and AF 760), N6 (between UPF 748 and DN 736), N7 (between SMF 746 and PCF 756), N8 (between UDM 758 and AMF 744), N9 (between two UPFs 748), N10 (between the UDM 758 and the SMF 746), N11 (between the AMF 744 and the SMF 746), N12 (between AUSF 742 and AMF 744), N13 (between AUSF 742 and UDM 758), N14 (between two AMFs 744; not shown), N15 (between PCF 756 and AMF 744 in case of a non-roaming scenario, or between the PCF 756 in a visited network and AMF 744 in case of a roaming scenario), N16 (between two SMFs 746; not shown), and N22 (between AMF 744 and NSSF 750). Other reference point representations not shown in FIG. 7 can also be used. The service-based representation of FIG. 7 represents NFs within the control plane that enable other authorized NFs to access their services. The service-based interfaces (SBIs) include: Namf (SBI exhibited by AMF 744), Nsmf (SBI exhibited by SMF 746), Nnef (SBI exhibited by NEF 752), Npcf (SBI exhibited by PCF 756), Nudm (SBI exhibited by the UDM 758), Naf (SBI exhibited by AF 760), Nnrf (SBI exhibited by NRF 754), Nnssf (SBI exhibited by NSSF 750), Nausf (SBI exhibited by AUSF 742). Other service-based interfaces (e.g., Nudr, N5g-eir, and Nudsf) not shown in FIG. 7 can also be used. In some embodiments, the NEF 752 can provide an interface to edge compute nodes 736x, which can be used to process wireless connections with the RAN 714. In some implementations, the system 700 may include an SMSF, which is responsible for SMS subscription checking and verification, and relaying SM messages to/from the UE 702 to/from other entities, such as an SMS-GMSC/IWMSC/SMS-router. The SMS may also interact with AMF 744 and UDM 758 for a notification procedure that the UE 702 is available for SMS transfer (e.g., set a UE not reachable flag, and notifying UDM 758 when UE 702 is available for SMS).

The 5GS may also include an SCP (or individual instances of the SCP) that supports indirect communication (see e.g., 3GPP TS 23.501 section 7.1.1); delegated discovery (see e.g., 3GPP TS 23.501 section 7.1.1); message forwarding and routing to destination NF/NF service(s), communication security (e.g., authorization of the NF Service Consumer to access the NF Service Producer API) (see e.g., 3GPP TS 33.501), load balancing, monitoring, overload control, etc.; and discovery and selection functionality for UDM(s), AUSF(s), UDR(s), PCF(s) with access to subscription data stored in the UDR based on UE's SUPI, SUCI or GPSI (see e.g., 3GPP TS 23.501 section 6.3). Load balancing, monitoring, overload control functionality provided by the SCP may be implementation specific. The SCP may be deployed in a distributed manner. More than one SCP can be present in the communication path between various NF Services. The SCP, although not an NF instance, can also be deployed distributed, redundant, and scalable.

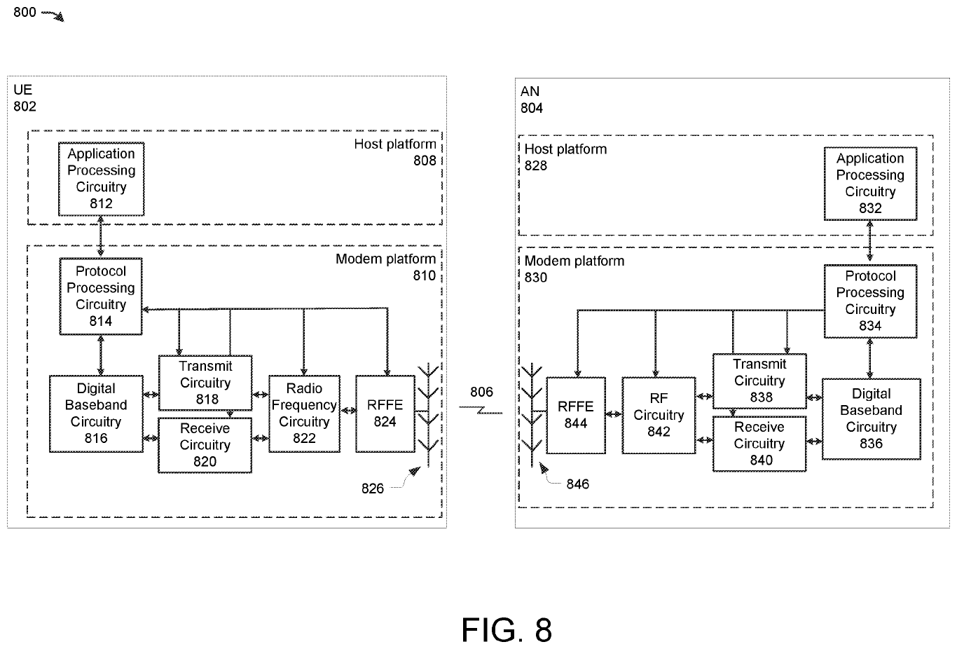

FIG. 8 schematically illustrates a wireless network 800 in accordance with various embodiments. The wireless network 800 may include a UE 802 in wireless communication with an AN 804. The UE 802 and AN 804 may be similar to, and substantially interchangeable with, like-named components described with respect to FIG. 7.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mmWave or sub-6 GHz frequencies.

The UE 802 may include a host platform 808 coupled with a modem platform 810. The host platform 808 may include application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations may include transport (for example UDP) and Internet (for example, IP) operations

The protocol processing circuitry 814 may implement one or more of layer operations to facilitate transmission or reception of data over the connection 806. The layer operations implemented by the protocol processing circuitry 814 may include, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations may include, for example, PHY operations including one or more of HARQ acknowledgement (ACK) functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which may include or connect to one or more antenna panels 826. Briefly, the transmit circuitry 818 may include a digital-to-analog converter, mixer, intermediate frequency (IF) components, etc.; the receive circuitry 820 may include an analog-to-digital converter, mixer, IF components, etc.; the RF circuitry 822 may include a low-noise amplifier, a power amplifier, power tracking components, etc.; RFFE 824 may include filters (for example, surface/bulk acoustic wave filters), switches, antenna tuners, beamforming components (for example, phase-array antenna components), etc. The selection and arrangement of the components of the transmit circuitry 818, receive circuitry 820, RF circuitry 822, RFFE 824, and antenna panels 826 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 814 may include one or more instances of control circuitry (not shown) to provide control functions for the transmit/receive components.

A UE 802 reception may be established by and via the antenna panels 826, RFFE 824, RF circuitry 822, receive circuitry 820, digital baseband circuitry 816, and protocol processing circuitry 814. In some embodiments, the antenna panels 826 may receive a transmission from the AN 804 by receive-beamforming signals received by a plurality of antennas/antenna elements of the one or more antenna panels 826.

A UE 802 transmission may be established by and via the protocol processing circuitry 814, digital baseband circuitry 816, transmit circuitry 818, RF circuitry 822, RFFE 824, and antenna panels 826. In some embodiments, the transmit components of the UE 804 may apply a spatial filter to the data to be transmitted to form a transmit beam emitted by the antenna elements of the antenna panels 826.

Similar to the UE 802, the AN 804 may include a host platform 828 coupled with a modem platform 830. The host platform 828 may include application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

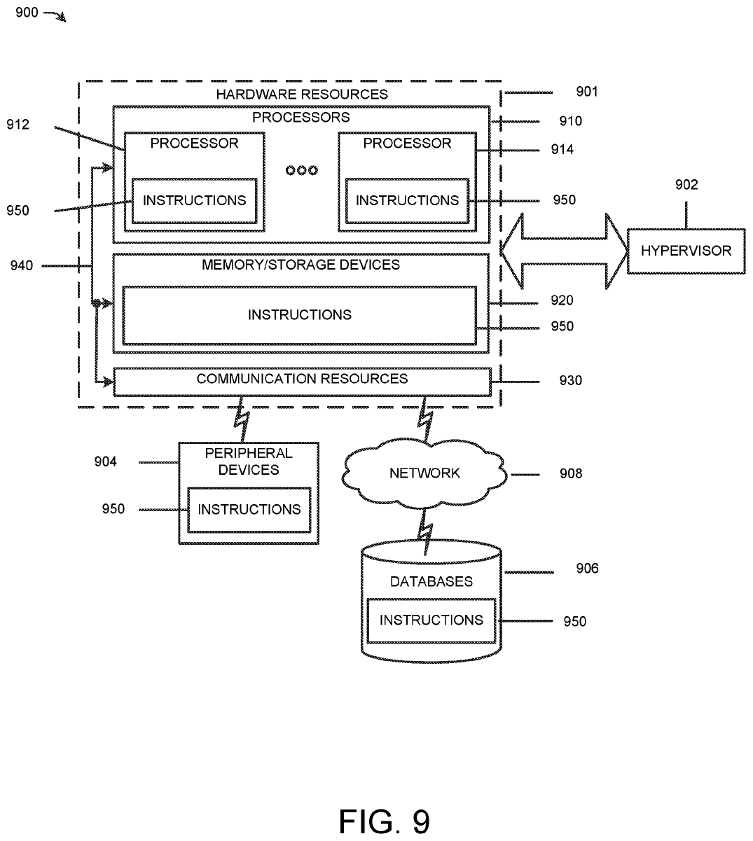

FIG. 9 illustrates components of a computing device 900 according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 901 including one or more processors (or processor cores) 910, one or more memory/storage devices 920, and one or more communication resources 930, each of which may be communicatively coupled via a bus 940 or other interface circuitry. For embodiments where node virtualization (e.g., NFV) is utilized, a hypervisor 902 may be executed to provide an execution environment for one or more network slices/sub-slices to utilize the hardware resources 901.

The processors 910 include, for example, processor 912 and processor 914. The processors 910 include circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. The processors 910 may be, for example, a central processing unit (CPU), reduced instruction set computing (RISC) processors, Acorn RISC Machine (ARM) processors, complex instruction set computing (CISC) processors, graphics processing units (GPUs), one or more Digital Signal Processors (DSPs) such as a baseband processor, Application-Specific Integrated Circuits (ASICs), an Field-Programmable Gate Array (FPGA), a radio-frequency integrated circuit (RFIC), one or more microprocessors or controllers, another processor (including those discussed herein), or any suitable combination thereof. In some implementations, the processor circuitry 910 may include one or more hardware accelerators, which may be microprocessors, programmable processing devices (e.g., FPGA, complex programmable logic devices (CPLDs), etc.), or the like.

The memory/storage devices 920 may include main memory, disk storage, or any suitable combination thereof. The memory/storage devices 920 may include, but are not limited to, any type of volatile, non-volatile, or semi-volatile memory such as random access memory (RAM), dynamic RAM (DRAM), static RAM (SRAM), synchronous DRAM (SDRAM), erasable programmable read-only memory (EPROM), electrically erasable programmable read-only memory (EEPROM), Flash memory, solid-state storage, phase change RAM (PRAM), resistive memory such as magnetoresistive random access memory (MRAM), etc., and may incorporate three-dimensional (3D) cross-point (XPOINT) memories from Intel® and Micron®. The memory/storage devices 920 may also comprise persistent storage devices, which may be temporal and/or persistent storage of any type, including, but not limited to, non-volatile memory, optical, magnetic, and/or solid state mass storage, and so forth.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, Ethernet, Ethernet over GRE Tunnels, Ethernet over Multiprotocol Label Switching (MPLS), Ethernet over USB, Controller AreaNetwork (CAN), Local Interconnect Network (LIN), DeviceNet, ControlNet, Data Highway+, PROFIBUS, or PROFINET, among many others), cellular communication components, NFC components, Bluetooth® (or Bluetooth® Low Energy) components, WiFi® components, and other communication components. Network connectivity may be provided to/from the computing device 900 via the communication resources 930 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The communication resources 930 may include one or more dedicated processors and/or FPGAs to communicate using one or more of the aforementioned network interface protocols.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 901 from any combination of the peripheral devices 904 or the databases 906. Accordingly, the memory of processors 910, the memory/storage devices 920, the peripheral devices 904, and the databases 906 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Additional examples of the presently described embodiments include the following, non-limiting implementations. Each of the following non-limiting examples may stand on its own or may be combined in any permutation or combination with any one or more of the other examples provided below or throughout the present disclosure.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

The following examples pertain to further embodiments.

Example 1 may include an apparatus for a UE comprising processing circuitry configured to decode a configuration for a Downlink Control Information (DCI) format for multi-cell scheduling comprising a DCI; validate the DCI based on whether it may be scrambled with a cell radio network temporary identifier (CS-RNTI) or a specific RNTI; and activate a semi-persistent scheduling physical downlink shared control channel (SPS PDSCH) reception or a Type 2 configured grant physical uplink shared channel (CG PUSCH) transmission; and release the SPS PDSCH reception or the CG PUSCH transmission based on the validation of the DCI.

Example 2 may include the apparatus of example 1 and/or some other example herein, wherein the processing circuitry may be further configured to determine whether the DCI indicates Scell dormancy, a TCI update, or HARQ-ACK codebook transmission/retransmission without scheduling a PDSCH.

Example 3 may include the apparatus of example 1 and/or some other example herein, wherein the DCI indicates Scell dormancy, or TCI update, or HARQ-ACK codebook transmission/retransmission without scheduling a PDSCH, if the DCI may be scrambled with RNTI and a corresponding bit field in the DCI may be validated.

Example 4 may include the apparatus of example 1 and/or some other example herein, wherein the DCI indicates no more than one serving cell.

Example 5 may include the apparatus of example 1 and/or some other example herein, wherein the DCI indicates one or more cells when scrambled with CS-RNTI and validates the DCI for activation or release by checking the corresponding bit field for the indicated cells.

Example 6 may include the apparatus of example 1 and/or some other example herein, wherein the processing circuitry may be further configured to apply a single SPS PDSCH or CG PUSCH configuration index bit field commonly for all scheduled cells indicated in the DCI or the cells in a cell group when the DCI activates SPS PDSCH or CG PUSCH with multi-cell scheduling.

Example 7 may include the apparatus of example 1 and/or some other example herein, wherein the processing circuitry may be further configured to report HARQ-ACK of all activated SPS PDSCHs in the same Physical Uplink Control Channel (PUCCH) when the DCI activates multiple SPS PDSCHs in multiple serving cells.

Example 8 may include the apparatus of example 1 and/or some other example herein, wherein the processing circuitry may be further configured to report HARQ-ACK of the DCI in HARQ-ACK bit location for a serving cell with the lowest cell index when the DCI releases SPS PDSCHs in multiple serving cells for a type-1 HARQ-ACK codebook.

Example 9 may include the apparatus of example 1 and/or some other example herein, wherein the processing circuitry may be further configured to transmit HARQ-ACK bit for dynamic TCI indication and HARQ-ACK for SPS PDSCH if a type-2 HARQ-ACK codebook may be configured and the DCI indicates Scell dormancy and schedules dynamic PDSCH for one or more indicated cells.

Example 10 may include a computer-readable medium storing computer-executable instructions which when executed by one or more processors result in performing operations comprising: decoding a configuration for a Downlink Control Information (DCI) format for multi-cell scheduling comprising a DCI; validating the DCI based on whether it may be scrambled with a cell radio network temporary identifier (CS-RNTI) or a specific RNTI; and activating a semi-persistent scheduling physical downlink shared control channel (SPS PDSCH) reception or a Type 2 configured grant physical uplink shared channel (CG PUSCH) transmission; and releasing the SPS PDSCH reception or the CG PUSCH transmission based on the validation of the DCI.

Example 11 may include the computer-readable medium of example 10 and/or some other example herein, wherein the operations further comprise determining whether the DCI indicates Scell dormancy, a TCI update, or HARQ-ACK codebook transmission/retransmission without scheduling a PDSCH.

Example 12 may include the computer-readable medium of example 10 and/or some other example herein, wherein the DCI indicates Scell dormancy, or TCI update, or HARQ-ACK codebook transmission/retransmission without scheduling a PDSCH, if the DCT may be scrambled with RNTI and a corresponding bit field in the DCI may be validated.

Example 13 may include the computer-readable medium of example 10 and/or some other example herein, wherein the DCI indicates no more than one serving cell.

Example 14 may include the computer-readable medium of example 10 and/or some other example herein, wherein the DCI indicates one or more cells when scrambled with CS-RNTI and validates the DCI for activation or release by checking the corresponding bit field for the indicated cells.

Example 15 may include the computer-readable medium of example 10 and/or some other example herein, wherein the operations further comprise applying a single SPS PDSCH or CG PUSCH configuration index bit field commonly for all scheduled cells indicated in the DCI or the cells in a cell group when the DCI activates SPS PDSCH or CG PUSCH with multi-cell scheduling.

Example 16 may include the computer-readable medium of example 10 and/or some other example herein, wherein the operations further comprise reporting HARQ-ACK of all activated SPS PDSCHs in the same Physical Uplink Control Channel (PUCCH) when the DCI activates multiple SPS PDSCHs in multiple serving cells.

Example 17 may include the computer-readable medium of example 10 and/or some other example herein, wherein the operations further comprise reporting HARQ-ACK of the DCI in HARQ-ACK bit location for a serving cell with the lowest cell index when the DCI releases SPS PDSCHs in multiple serving cells for a type-1 HARQ-ACK codebook.

Example 18 may include the computer-readable medium of example 10 and/or some other example herein, wherein the operations further comprise transmitting HARQ-ACK bit for dynamic TCI indication and HARQ-ACK for SPS PDSCH if a type-2 HARQ-ACK codebook may be configured and the DCI indicates Scell dormancy and schedules dynamic PDSCH for one or more indicated cells.

Example 19 may include a method comprising: decoding a configuration for a Downlink Control Information (DCI) format for multi-cell scheduling comprising a DCI; validating the DCI based on whether it may be scrambled with a cell radio network temporary identifier (CS-RNTI) or a specific RNTI; and activating a semi-persistent scheduling physical downlink shared control channel (SPS PDSCH) reception or a Type 2 configured grant physical uplink shared channel (CG PUSCH) transmission; and releasing the SPS PDSCH reception or the CG PUSCH transmission based on the validation of the DCI.

Example 20 may include the method of example 19 and/or some other example herein, further comprising determining whether the DCI indicates Scell dormancy, a TCI update, or HARQ-ACK codebook transmission/retransmission without scheduling a PDSCH.

Example 21 may include the method of example 19 and/or some other example herein, wherein the DCI indicates Scell dormancy, or TCI update, or HARQ-ACK codebook transmission/retransmission without scheduling a PDSCH, if the DCI may be scrambled with RNTI and a corresponding bit field in the DCI may be validated.

Example 22 may include the method of example 19 and/or some other example herein, wherein the DCI indicates no more than one serving cell.

Example 23 may include the method of example 19 and/or some other example herein, wherein the DCI indicates one or more cells when scrambled with CS-RNTI and validates the DCI for activation or release by checking the corresponding bit field for the indicated cells.

Example 24 may include the method of example 19 and/or some other example herein, further comprising applying a single SPS PDSCH or CG PUSCH configuration index bit field commonly for all scheduled cells indicated in the DCI or the cells in a cell group when the DCI activates SPS PDSCH or CG PUSCH with multi-cell scheduling.

Example 25 may include the method of example 19 and/or some other example herein, further comprising reporting HARQ-ACK of all activated SPS PDSCHs in the same Physical Uplink Control Channel (PUCCH) when the DCI activates multiple SPS PDSCHs in multiple serving cells.

Example 26 may include the method of example 19 and/or some other example herein, further comprising reporting HARQ-ACK of the DCI in HARQ-ACK bit location for a serving cell with the lowest cell index when the DCI releases SPS PDSCHs in multiple serving cells for a type-1 HARQ-ACK codebook.

Example 27 may include the method of example 19 and/or some other example herein, further comprising transmitting HARQ-ACK bit for dynamic TCI indication and HARQ-ACK for SPS PDSCH if a type-2 HARQ-ACK codebook may be configured and the DCI indicates Scell dormancy and schedules dynamic PDSCH for one or more indicated cells.

Example 28 may include an apparatus comprising means for: decoding a configuration for a Downlink Control Information (DCI) format for multi-cell scheduling comprising a DCI; validating the DCI based on whether it may be scrambled with a cell radio network temporary identifier (CS-RNTI) or a specific RNTI; and activating a semi-persistent scheduling physical downlink shared control channel (SPS PDSCH) reception or a Type 2 configured grant physical uplink shared channel (CG PUSCH) transmission; and releasing the SPS PDSCH reception or the CG PUSCH transmission based on the validation of the DCI.

Example 29 may include the apparatus of example 28 and/or some other example herein, further comprising determining whether the DCI indicates Scell dormancy, a TCI update, or HARQ-ACK codebook transmission/retransmission without scheduling a PDSCH.

Example 30 may include the apparatus of example 28 and/or some other example herein, wherein the DCI indicates Scell dormancy, or TCI update, or HARQ-ACK codebook transmission/retransmission without scheduling a PDSCH, if the DCI may be scrambled with RNTI and a corresponding bit field in the DCI may be validated.

Example 31 may include the apparatus of example 28 and/or some other example herein, wherein the DCI indicates no more than one serving cell.

Example 32 may include the apparatus of example 28 and/or some other example herein, wherein the DCI indicates one or more cells when scrambled with CS-RNTI and validates the DCI for activation or release by checking the corresponding bit field for the indicated cells.

Example 33 may include the apparatus of example 28 and/or some other example herein, further comprising applying a single SPS PDSCH or CG PUSCH configuration index bit field commonly for all scheduled cells indicated in the DCI or the cells in a cell group when the DCI activates SPS PDSCH or CG PUSCH with multi-cell scheduling.

Example 34 may include the apparatus of example 28 and/or some other example herein, further comprising reporting HARQ-ACK of all activated SPS PDSCHs in the same Physical Uplink Control Channel (PUCCH) when the DCI activates multiple SPS PDSCHs in multiple serving cells.

Example 35 may include the apparatus of example 28 and/or some other example herein, further comprising reporting HARQ-ACK of the DCI in HARQ-ACK bit location for a serving cell with the lowest cell index when the DCI releases SPS PDSCHs in multiple serving cells for a type-1 HARQ-ACK codebook.

Example 36 may include the apparatus of example 28 and/or some other example herein, further comprising transmitting HARQ-ACK bit for dynamic TCI indication and HARQ-ACK for SPS PDSCH if a type-2 HARQ-ACK codebook may be configured and the DCI indicates Scell dormancy and schedules dynamic PDSCH for one or more indicated cells.

Example 37 may include an apparatus comprising means for performing any of the methods of examples 1-36.

Example 38 may include a UE comprising a communication interface and processing circuitry connected thereto and configured to perform the methods of examples 1-36.

Example 39 may include an apparatus comprising means to perform one or more elements of a method described in or related to any of examples 1-36, or any other method or process described herein.

Example 40 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 41 may include an apparatus comprising logic, modules, or circuitry to perform one or more elements of a method described in or related to any of examples 1-36, or any other method or process described herein.

Example 42 may include a method, technique, or process as described in or related to any of examples 1-36, or portions or parts thereof.

Example 43 may include an apparatus comprising: one or more processors and one or more computer-readable media comprising instructions that, when executed by the one or more processors, cause the one or more processors to perform the method, techniques, or process as described in or related to any of examples 1-36, or portions thereof.

Example 44 may include a signal as described in or related to any of examples 1-36, or portions or parts thereof.

Example 45 may include a datagram, packet, frame, segment, protocol data unit (PDU), or message as described in or related to any of examples 1-36, or portions or parts thereof, or otherwise described in the present disclosure.

Example 46 may include a signal encoded with data as described in or related to any of examples 1-36, or portions or parts thereof, or otherwise described in the present disclosure.

Example 47 may include a signal encoded with a datagram, packet, frame, segment, protocol data unit (PDU), or message as described in or related to any of examples 1-36, or portions or parts thereof, or otherwise described in the present disclosure.

Example 48 may include an electromagnetic signal carrying computer-readable instructions, wherein execution of the computer-readable instructions by one or more processors is to cause the one or more processors to perform the method, techniques, or process as described in or related to any of examples 1-36, or portions thereof.

Example 49 may include a computer program comprising instructions, wherein execution of the program by a processing element is to cause the processing element to carry out the method, techniques, or process as described in or related to any of examples 1-36, or portions thereof.

Example 50 may include a signal in a wireless network as shown and described herein.

Example 51 may include a method of communicating in a wireless network as shown and described herein.

Example 52 may include a system for providing wireless communication as shown and described herein.

Example 53 may include a device for providing wireless communication as shown and described herein.

An example implementation is an edge computing system, including respective edge processing devices and nodes to invoke or perform the operations of the examples above, or other subject matter described herein. Another example implementation is a client endpoint node, operable to invoke or perform the operations of the examples above, or other subject matter described herein. Another example implementation is an aggregation node, network hub node, gateway node, or core data processing node, within or coupled to an edge computing system, operable to invoke or perform the operations of the examples above, or other subject matter described herein. Another example implementation is an access point, base station, road-side unit, street-side unit, or on-premise unit, within or coupled to an edge computing system, operable to invoke or perform the operations of the examples above, or other subject matter described herein. Another example implementation is an edge provisioning node, service orchestration node, application orchestration node, or multi-tenant management node, within or coupled to an edge computing system, operable to invoke or perform the operations of the examples above, or other subject matter described herein. Another example implementation is an edge node operating an edge provisioning service, application or service orchestration service, virtual machine deployment, container deployment, function deployment, and compute management, within or coupled to an edge computing system, operable to invoke or perform the operations of the examples above, or other subject matter described herein. Another example implementation is an edge computing system operable as an edge mesh, as an edge mesh with side car loading, or with mesh-to-mesh communications, operable to invoke or perform the operations of the examples above, or other subject matter described herein. Another example implementation is an edge computing system including aspects of network functions, acceleration functions, acceleration hardware, storage hardware, or computation hardware resources, operable to invoke or perform the use cases discussed herein, with use of the examples above, or other subject matter described herein. Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of the examples above, or other subject matter described herein. Another example implementation is an edge computing system adapted for mobile wireless communications, including configurations according to an 3GPP 4G/LTE or 5G network capabilities, operable to invoke or perform the use cases discussed herein, with use of the examples above, or other subject matter described herein. Another example implementation is a computing system adapted for network communications, including configurations according to an O-RAN capabilities, operable to invoke or perform the use cases discussed herein, with use of the examples above, or other subject matter described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Terminology

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource. The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, the term “edge computing” refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership). As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” or “edge computing network” generally refer to a distributed architecture, organization, or collection of multiple nodes and devices, and which is organized to accomplish or offer some aspect of services or resources in an edge computing setting.

Additionally or alternatively, the term “Edge Computing” refers to a concept, as described in [6], that enables operator and 3rd party services to be hosted close to the UE's access point of attachment, to achieve an efficient service delivery through the reduced end-to-end latency and load on the transport network. As used herein, the term “Edge Computing Service Provider” refers to a mobile network operator or a 3rd party service provider offering Edge Computing service. As used herein, the term “Edge Data Network” refers to a local Data Network (DN) that supports the architecture for enabling edge applications. As used herein, the term “Edge Hosting Environment” refers to an environment providing support required for Edge Application Server's execution. As used herein, the term “Application Server” refers to application software resident in the cloud performing the server function.

The term “Internet of Things” or “IoT” refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. “Edge IoT devices” may be any kind of IoT devices deployed at a network's edge.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “application” may refer to a complete and deployable package, environment to achieve a certain function in an operational environment. The term “AI/ML application” or the like may be an application that contains some AI/ML models and application-level descriptions. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

The terms “instantiate,” “instantiation,” and the like as used herein refers to the creation of an instance. An “instance” also refers to a concrete occurrence of an object, which may occur, for example, during execution of program code. The term “information element” refers to a structural element containing one or more fields. The term “field” refers to individual contents of an information element, or a data element that contains content. As used herein, a “database object”, “data structure”, or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in block chain implementations, and/or the like.

An “information object,” as used herein, refers to a collection of structured data and/or any representation of information, and may include, for example electronic documents (or “documents”), database objects, data structures, files, audio data, video data, raw data, archive files, application packages, and/or any other like representation of information. The terms “electronic document” or “document,” may refer to a data structure, computer file, or resource used to record data, and includes various file types and/or data formats such as word processing documents, spreadsheets, slide presentations, multimedia items, webpage and/or source code documents, and/or the like. As examples, the information objects may include markup and/or source code documents such as HTML, XML, JSON, Apex®, CSS, JSP, MessagePack™, Apache® Thrift™, ASN.1, Google® Protocol Buffers (protobuf), or some other document(s)/format(s) such as those discussed herein. An information object may have both a logical and a physical structure. Physically, an information object comprises one or more units called entities. An entity is a unit of storage that contains content and is identified by a name. An entity may refer to other entities to cause their inclusion in the information object. An information object begins in a document entity, which is also referred to as a root element (or “root”). Logically, an information object comprises one or more declarations, elements, comments, character references, and processing instructions, all of which are indicated in the information object (e.g., using markup).

The term “data item” as used herein refers to an atomic state of a particular object with at least one specific property at a certain point in time. Such an object is usually identified by an object name or object identifier, and properties of such an object are usually defined as database objects (e.g., fields, records, etc.), object instances, or data elements (e.g., mark-up language elements/tags, etc.). Additionally or alternatively, the term “data item” as used herein may refer to data elements and/or content items, although these terms may refer to difference concepts. The term “data element” or “element” as used herein refers to a unit that is indivisible at a given level of abstraction and has a clearly defined boundary. A data element is a logical component of an information object (e.g., electronic document) that may begin with a start tag (e.g., “<element>”) and end with a matching end tag (e.g., “</element>”), or only has an empty element tag (e.g., “<element/>”). Any characters between the start tag and end tag, if any, are the element's content (referred to herein as “content items” or the like).

The content of an entity may include one or more content items, each of which has an associated datatype representation. A content item may include, for example, attribute values, character values, URIs, qualified names (qnames), parameters, and the like. A qname is a fully qualified name of an element, attribute, or identifier in an information object. A qname associates a URI of a namespace with a local name of an element, attribute, or identifier in that namespace. To make this association, the qname assigns a prefix to the local name that corresponds to its namespace. The qname comprises a URI of the namespace, the prefix, and the local name. Namespaces are used to provide uniquely named elements and attributes in information objects. Content items may include text content (e.g., “<element>content item</element>”), attributes (e.g., “<element attribute=“attributeValue”>”), and other elements referred to as “child elements” (e.g., “<element1><element2>content item</element2></element1>”). An “attribute” may refer to a markup construct including a name-value pair that exists within a start tag or empty element tag. Attributes contain data related to its element and/or control the element's behavior.

The term “channel” as used herein refers to any transmission medium, either tangible or intangible, which is used to communicate data or a data stream. The term “channel” may be synonymous with and/or equivalent to “communications channel,” “data communications channel,” “transmission channel.” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information. As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like. Examples of wireless communications protocols may be used in various embodiments include a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology including, for example, 3GPP Fifth Generation (5G) or New Radio (NR), Universal Mobile Telecommunications System (UMTS), Freedom of Multimedia Access (FOMA), Long Term Evolution (LTE), LTE-Advanced (LTE Advanced), LTE Extra, LTE-A Pro, cdmaOne (2G), Code Division Multiple Access 2000 (CDMA 2000), Cellular Digital Packet Data (CDPD), Mobitex, Circuit Switched Data (CSD), High-Speed CSD (HSCSD), Universal Mobile Telecommunications System (UMTS), Wideband Code Division Multiple Access (W-CDM), High Speed Packet Access (HSPA), HSPA Plus (HSPA+), Time Division-Code Division Multiple Access (TD-CDMA), Time Division-Synchronous Code Division Multiple Access (TD-SCDMA), LTE LAA, MuLTEfire, UMTS Terrestrial Radio Access (UTRA), Evolved UTRA (E-UTRA), Evolution-Data Optimized or Evolution-Data Only (EV-DO), Advanced Mobile Phone System (AMPS), Digital AMPS (D-AMPS), Total Access Communication System/Extended Total Access Comnmunication System (TACS/ETACS), Push-to-talk (PTT), Mobile Telephone System (MTS), Improved Mobile Telephone System (IMTS), Advanced Mobile Telephone System (AMTS), Cellular Digital Packet Data (CDPD), DataTAC, Integrated Digital Enhanced Network (iDEN), Personal Digital Cellular (PDC), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, 802.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), Long Range Wide Area Network (LoRA) or LoRaWAN™ developed by Semtech and the LoRa Alliance, Sigfox, Wireless Gigabit Alliance (WiGig) standard, Worldwide Interoperability for Microwave Access (WiMAX), mmWave standards in general (e.g., wireless systems operating at 10-300 GHz and above such as WiGig, IEEE 802.11ad, IEEE 802.11ay, etc.), V2X communication technologies (including 3GPP C-V2X), Dedicated Short Range Communications (DSRC) communication systems such as Intelligent-Transport-Systems (ITS) including the European ITS-G5, ITS-G5B, ITS-G5C, etc. In addition to the standards listed above, any number of satellite uplink technologies may be used for purposes of the present disclosure including, for example, radios compliant with standards issued by the International Telecommunication Union (ITU), or the European Telecommunications Standards Institute (ETSI), among others. The examples provided herein are thus understood as being applicable to various other communication technologies, both existing and not yet formulated.

The term “access network” refers to any network, using any combination of radio technologies, RATs, and/or communication protocols, used to connect user devices and service providers. In the context of WLANs, an “access network” is an IEEE 802 local area network (LAN) or metropolitan area network (MAN) between terminals and access routers connecting to provider services. The term “access router” refers to router that terminates a medium access control (MAC) service from terminals and forwards user traffic to information servers according to Internet Protocol (IP) addresses.

The term “SMTC” refers to an SSB-based measurement timing configuration configured by SSB-MeasurementTimingConfiguration. The term “SSB” refers to a synchronization signal/Physical Broadcast Channel (SS/PBCH) block, which includes a Primary Syncrhonization Signal (PSS), a Secondary Syncrhonization Signal (SSS), and a PBCH. The term “a “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation; otherwise, the term “Special Cell” refers to the Pcell.

The term “A1 policy” refers to a type of declarative policies expressed using formal statements that enable the non-RT RIC function in the SMO to guide the near-RT RIC function, and hence the RAN, towards better fulfilment of the RAN intent.

The term “A1 Enrichment information” refers to information utilized by near-RT RIC that is collected or derived at SMO/non-RT RIC either from non-network data sources or from network functions themselves.

The term “A1-Policy Based Traffic Steering Process Mode” refers to an operational mode in which the Near-RT RIC is configured through A1 Policy to use Traffic Steering Actions to ensure a more specific notion of network performance (for example, applying to smaller groups of E2 Nodes and UEs in the RAN) than that which it ensures in the Background Traffic Steering.

The term “Background Traffic Steering Processing Mode” refers to an operational mode in which the Near-RT RIC is configured through O1 to use Traffic Steering Actions to ensure a general background network performance which applies broadly across E2 Nodes and UEs in the RAN.

The term “Baseline RAN Behavior” refers to the default RAN behavior as configured at the E2 Nodes by SMO The term “E2” refers to an interface connecting the Near-RT RIC and one or more O-CU-CPs, one or more O-CU-UPs, one or more O-DUs, and one or more O-eNBs.

The term “E2 Node” refers to a logical node terminating E2 interface. In this version of the specification, ORAN nodes terminating E2 interface are: for NR access: O-CU-CP, O-CU-UP, O-DU or any combination; and for E-UTRA access: O-eNB.

The term “Intents”, in the context of O-RAN systems/implementations, refers to declarative policy to steer or guide the behavior of RAN functions, allowing the RAN function to calculate the optimal result to achieve stated objective.

The term “O-RAN non-real-time RAN Intelligent Controller” or “non-RT RIC” refers to a logical function that enables non-real-time control and optimization of RAN elements and resources, AI/ML workflow including model training and updates, and policy-based guidance of applications/features in Near-RT RIC.

The term “Near-RT RIC” or “O-RAN near-real-time RAN Intelligent Controller” refers to a logical function that enables near-real-time control and optimization of RAN elements and resources via fine-grained (e.g., UE basis, Cell basis) data collection and actions over E2 interface.

The term “O-RAN Central Unit” or “O-CU” refers to a logical node hosting RRC, SDAP and PDCP protocols.

The term “O-RAN Central Unit-Control Plane” or “O-CU-CP” refers to a logical node hosting the RRC and the control plane part of the PDCP protocol.

The term “O-RAN Central Unit-User Plane” or “O-CU-UP” refers to a logical node hosting the user plane part of the PDCP protocol and the SDAP protocol

The term “O-RAN Distributed Unit” or “O-DU” refers to a logical node hosting RLC/MAC/High-PHY layers based on a lower layer functional split.

The term “O-RAN eNB” or “O-eNB” refers to an eNB or ng-eNB that supports E2 interface.

The term “O-RAN Radio Unit” or “O-RU” refers to a logical node hosting Low-PHY layer and RF processing based on a lower layer functional split. This is similar to 3GPP's “TRP” or “RRH” but more specific in including the Low-PHY layer (FFT/iFFT, PRACH extraction).

The term “O1” refers to an interface between orchestration & management entities (Orchestration/NMS) and O-RAN managed elements, for operation and management, by which FCAPS management, Software management, File management and other similar functions shall be achieved.

The term “RAN UE Group” refers to an aggregations of UEs whose grouping is set in the E2 nodes through E2 procedures also based on the scope of A1 policies. These groups can then be the target of E2 CONTROL or POLICY messages.

The term “Traffic Steering Action” refers to the use of a mechanism to alter RAN behavior. Such actions include E2 procedures such as CONTROL and POLICY.

The term “Traffic Steering Inner Loop” refers to the part of the Traffic Steering processing, triggered by the arrival of periodic TS related KPM (Key Performance Measurement) from E2 Node, which includes UE grouping, setting additional data collection from the RAN, as well as selection and execution of one or more optimization actions to enforce Traffic Steering policies.

The term “Traffic Steering Outer Loop” refers to the part of the Traffic Steering processing, triggered by the near-RT RIC setting up or updating Traffic Steering aware resource optimization procedure based on information from A1 Policy setup or update, A1 Enrichment Information (EI) and/or outcome of Near-RT RIC evaluation, which includes the initial configuration (preconditions) and injection of related A1 policies, Triggering conditions for TS changes.

The term “Traffic Steering Processing Mode” refers to an operational mode in which either the RAN or the Near-RT RIC is configured to ensure a particular network performance.

This performance includes such aspects as cell load and throughput, and can apply differently to different E2 nodes and UEs. Throughout this process, Traffic Steering Actions are used to fulfill the requirements of this configuration.

The term “Traffic Steering Target” refers to the intended performance result that is desired from the network, which is configured to Near-RT RIC over O1.

Furthermore, any of the disclosed embodiments and example implementations can be embodied in the form of various types of hardware, software, firmware, middleware, or combinations thereof, including in the form of control logic, and using such hardware or software in a modular or integrated manner. Additionally, any of the software components or functions described herein can be implemented as software, program code, script, instructions, etc., operable to be executed by processor circuitry. These components, functions, programs, etc., can be developed using any suitable computer language such as, for example, Python, PyTorch, NumPy, Ruby, Ruby on Rails, Scala, Smalltalk, Java™, C++, C#, “C”, Kotlin, Swift, Rust, Go (or “Golang”), EMCAScript, JavaScript, TypeScript, Jscript, ActionScript, Server-Side JavaScript (SSJS), PHP, Pearl, Lua, Torch/Lua with Just-In Time compiler (LuaJIT), Accelerated Mobile Pages Script (AMPscript), VBScript, JavaServer Pages (JSP), Active Server Pages (ASP), Node.js, ASP.NET, JAMscript, Hypertext Markup Language (HTML), extensible HTML (XHTML), Extensible Markup Language (XML), XML User Interface Language (XUL), Scalable Vector Graphics (SVG), RESTful API Modeling Language (RAML), wiki markup or Wikitext, Wireless Markup Language (WML), Java Script Object Notion (JSON), Apache® MessagePack™, Cascading Stylesheets (CSS), extensible stylesheet language (XSL), Mustache template language, Handlebars template language, Guide Template Language (GTL), Apache® Thrift, Abstract Syntax Notation One (ASN.1), Google® Protocol Buffers (protobuf), Bitcoin Script, EVM® bytecode, Solidity™, Vyper (Python derived), Bamboo, Lisp Like Language (LLL), Simplicity provided by Blockstream™, Rholang, Michelson, Counterfactual, Plasma, Plutus, Sophia, Salesforce® Apex®, and/or any other programming language or development tools including proprietary programming languages and/or development tools. The software code can be stored as a computer- or processor-executable instructions or commands on a physical non-transitory computer-readable medium. Examples of suitable media include RAM, ROM, magnetic media such as a hard-drive or a floppy disk, or an optical medium such as a compact disk (CD) or DVD (digital versatile disk), flash memory, and the like, or any combination of such storage or transmission devices.

### Abbreviations

Unless used differently herein, terms, definitions, and abbreviations may be consistent with terms, definitions, and abbreviations defined in 3GPP TR 21.905 v 16.0.0 (2019 June). For the purposes of the present document, the following abbreviations may apply to the examples and embodiments discussed herein.

TABLE 1
Abbreviations:

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate Maximum Bit |
| | Rate |
| AMF | Access and Mobility |
| | Management Function |
| AN | Access Network |
| ANR | Automatic Neighbour |
| | Relation |
| AP | Application Protocol, |
| | Antenna Port, Access |
| | Point |
| API | Application Programming |
| | Interface |
| APN | Access Point Name |
| ARP | Allocation and Retention |
| | Priority |
| ARQ | Automatic Repeat Request |
| AS | Access Stratum |
| ASP | Application Service |
| | Provider |
| ASN.1 | Abstract Syntax Notation |
| | One |
| AUSF | Authentication Server |
| | Function |
| AWGN | Additive White Gaussian |
| | Noise |
| BAP | Backhaul Adaptation |
| | Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote |
| | Access Server |
| BSS | Business Support System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based Random |
| | Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple |
| | Access |
| CFRA | Contention Free Random |
| | Access |
| CG | Cell Group |
| CGF | Charging Gateway |
| | Function |
| CHF | Charging Function |
| CI | Cell Identity |
| CID | Cell-ID (e.g., positioning |
| | method) |
| CIM | Common Information |
| | Model |
| CIR | Carrier to Interference |
| | Ratio |
| CK | Cipher Key |
| CM | Connection Management, |
| | Conditional Mandatory |
| CMAS | Commercial Mobile Alert |
| | Service |
| CMD | Command |
| CMS | Cloud Management |
| | System |
| CO | Conditional Optional |
| CoMP | Coordinated Multi-Point |
| CORESET | Control Resource Set |
| COTS | Commercial Off-The- |
| | Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot Channel |
| CQI | Channel Quality Indicator |
| CPU | CSI processing unit, |
| | Central Processing Unit |
| C/R | Command/Response field |
| | bit |
| CRAN | Cloud Radio Access |
| | Network, Cloud RAN |
| CRB | Common Resource Block |
| CRC | Cyclic Redundancy Check |
| CRI | Channel-State Information |
| | Resource Indicator, CSI- |
| | RS Resource Indicator |
| C-RNTI | Cell RNTI |
| CS | Circuit Switched |
| CSAR | Cloud Service Archive |
| CSI | Channel-State Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise and |
| | interference ratio |
| CSMA | Carrier Sense Multiple |
| | Access |
| CSMA/CA | CSMA with collision |
| | avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, DMRS | Demodulation |
| | Reference Signal |
| DN | Data network |
| DNN | Data Network Name |
| DNAI | Data Network Access |
| | Identifier |
| DRB | Data Radio Bearer |
| DRS | Discovery Reference |
| | Signal |
| DRX | Discontinuous Reception |
| DSL | Domain Specific |
| | Language. Digital |
| | Subscriber Line |
| DSLAM | DSL Access Multiplexer |
| DwPTS | Downlink Pilot Time Slot |
| E-LAN | Ethernet Local Area |
| | Network |
| E2E | End-to-End |
| ECCA | extended clear channel |
| | assessment, extended |
| | CCA |
| ECCE | Enhanced Control |
| | Channel Element, |
| | Enhanced CCE |
| ED | Energy Detection |
| EDGE | Enhanced Datarates for |
| | GSM Evolution (GSM |
| | Evolution) |
| EAS | Edge Application Server |
| EASID | Edge Application Server |
| | Identification |
| ECS | Edge Configuration Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting |
| | Environment |
| EGMF | Exposure Governance |
| | tableManagement |
| | Function |
| EGPRS | Enhanced GPRS |
| EIR | Equipment Identity |
| | Register |
| eLAA | enhanced Licensed |
| | Assisted Access, enhanced |
| | LAA |
| EM | Element Manager |
| eMBB | Enhanced Mobile |
| | Broadband |
| EMS | Element Management |
| | System |
| eNB | evolved NodeB, E- |
| | UTRAN Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, enhanced |
| | resource element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division |
| | Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier |
| | Transformation |
| feLAA | further enhanced Licensed |
| | Assisted Access, further |
| | enhanced LAA |
| FN | Frame Number |
| FPGA | Field-Programmable Gate |
| | Array |
| FR | Frequency Range |
| FQDN | Fully Qualified Domain |
| | Name |
| G-RNTI | GERAN Radio Network |
| | Temporary Identity |
| GERAN | GSM EDGE RAN, GSM |
| | EDGE Radio Access |
| | Network |
| GGSN | Gateway GPRS Support |
| | Node |
| GLONASS | GLObal'naya |
| | NAvigatsionnaya |
| | Sputnikovaya Sistema |
| | (Engl.: Global Navigation |
| | Satellite System) |
| gNB | Next Generation NodeB |
| gNB-CU | gNB-centralized unit, Next |
| | Generation NodeB |
| | centralized unit |
| gNB-DU | gNB-distributed unit, Next |
| | Generation NodeB |
| | distributed unit |
| GNSS | Global Navigation |
| | Satellite System |
| GPRS | General Packet Radio |
| | Service |
| GPSI | Generic Public |
| | Subscription Identifier |
| GSM | Global System for Mobile |
| | Communications, Groupe |
| | Spécial Mobile |
| GTP | GPRS Tunneling Protocol |
| GTP-U | GPRS Tunnelling Protocol |
| | for User Plane |
| GTS | Go To Sleep Signal |
| | (related to WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile |
| | Network |
| HSDPA | High Speed Downlink |
| | Packet Access |
| HSN | Hopping Sequence |
| | Number |
| HSPA | High Speed Packet Access |
| HSS | Home Subscriber Server |
| HSUPA | High Speed Uplink Packet |
| | Access |
| HTTP | Hyper Text Transfer |
| | Protocol |
| HTTPS | Hyper Text Transfer |
| | Protocol Secure (https is |
| | http/1.1 over SSL, i.e. port |
| | 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical |
| | and Electronics |
| | Engineers |
| IEI | Information Element |
| | Identifier |
| IEIDL | Information Element |
| | Identifier Data Length |
| IETF | Internet Engineering |
| | Task Force |
| IF | Infrastructure |
| IM | Interference |
| | Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI | IP Multimedia Private |
| | Identity |
| IMPU | IP Multimedia PUblic |
| | identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, Internet |
| | Protocol Security |
| IP-CAN | IP-Connectivity |
| | Access Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration Reference |
| | Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking-Function |
| I-WLAN | Interworking WLAN |
| | Constraint length of the |
| | convolutional code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key Performance |
| | Indicator |
| KQI | Key Quality Indicator |
| KSI | Key Set Identifier |
| ksps | kilo-symbols per |
| | second |
| KVM | Kernel Virtual |
| | Machine |
| L1 | Layer 1 (physical |
| | layer) |
| L1-RSRP | Layer 1 reference |
| | signal received power |
| L2 | Layer 2 (data link |
| | layer) |
| L3 | Layer 3 (network |
| | layer) |
| LAA | Licensed Assisted |
| | Access |
| LAN | Local Area Network |
| LADN | Local Area Data |
| | Network |
| LBT | Listen Before Talk |
| LCM | LifeCycle |
| | Management |
| LCR | Low Chip Rate |
| LCS | Location Services |
| LCID | Logical Channel ID |
| LI | Layer Indicator |
| LLC | Logical Link Control, |
| | Low Layer |
| | Compatibility |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN Radio |
| | Level Integration with |
| | IPsec Tunnel |
| LTE | Long Term Evolution |
| M2M | Machine-to-Machine |
| MAC | Medium Access |
| | Control (protocol |
| | layering context) |
| MAC | Message authentication |
| | code (security/encryption |
| | context) |
| MAC-A | MAC used for |
| | authentication and key |
| | agreement (TSG T |
| | WG3 context) |
| MAC-I | MAC used for data |
| | integrity of signalling |
| | messages (TSG T |
| | WG3 context) |
| MANO | Management and |
| | Orchestration |
| MBMS | Multimedia Broadcast |
| | and Multicast Service |
| MBSFN | Multimedia Broadcast |
| | multicast service |
| | Single Frequency |
| | Network |
| MCC | Mobile Country Code |
| MCG | Master Cell Group |
| MCOT | Maximum Channel |
| | Occupancy Time |
| MCS | Modulation and coding |
| | scheme |
| MDAF | Management Data |
| | Analytics Function |
| MDAS | Management Data |
| | Analytics Service |
| MDT | Minimization of Drive |
| | Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location |
| | Centre |
| MM | Mobility Management |
| MME | Mobility Management |
| | Entity |
| MN | Master Node |
| MNO | Mobile Network |
| | Operator |
| MO | Measurement Object, |
| | Mobile Originated |
| MPBCH | MTC Physical |
| | Broadcast CHannel |
| MPDCCH | MTC Physical |
| | Downlink Control |
| | CHannel |
| MPDSCH | MTC Physical |
| | Downlink Shared |
| | CHannel |
| MPRACH | MTC Physical |
| | Random Access |
| | CHannel |
| MPUSCH | MTC Physical Uplink |
| | Shared Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling |
| | Information |
| MSID | Mobile Station |
| | Identifier |
| MSIN | Mobile Station |
| | Identification Number |
| MSISDN | Mobile Subscriber |
| | ISDN Number |
| MT | Mobile Terminated, |
| | Mobile Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up signal, |
| | MTC WUS |
| NACK | Negative |
| | Acknowledgement |
| NAI | Network Access |
| | Identifier |
| NAS | Non-Access Stratum, |
| | Non-Access Stratum |
| | layer |
| NCT | Network Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network Forwarding |
| | Path |
| NFPD | Network Forwarding |
| | Path Descriptor |
| NFV | Network Functions |
| | Virtualization |
| NFVI | NFV Infrastructure |
| NFVO | NFV Orchestrator |
| NG | Next Generation, Next |
| | Gen |
| NGEN-DC | NG-RAN E-UTRA- |
| | NR Dual Connectivity |
| NM | Network Manager |
| NMS | Network Management |
| | System |
| N-PoP | Network Point of |
| | Presence |
| NMIB, N-MIB | Narrowband MIB |
| NPBCH | Narrowband Physical |
| | Broadcast CHannel |
| NPDCCH | Narrowband Physical |
| | Downlink Control |
| | CHannel |
| NPDSCH | Narrowband Physical |
| | Downlink Shared |
| | CHannel |
| NPRACH | Narrowband Physical |
| | Random Access |
| | CHannel |
| NPUSCH | Narrowband Physical |
| | Uplink Shared |
| | CHannel |
| NPSS | Narrowband Primary |
| | Synchronization Signal |
| NSSS | Narrowband |
| | Secondary |
| | Synchronization Signal |
| NR | New Radio, Neighbour |
| | Relation |
| NRF | NF Repository |
| | Function |
| NRS | Narrowband Reference |
| | Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection Assistance |
| | Information |
| S-NNSAI | Single-NSSAI |
| NSSF | Network Slice |
| | Selection Function |
| NW | Network |
| NWUS | Narrowband wake-up |
| | signal, Narrowband |
| | WUS |
| NZP | Non-Zero Power |
| O&M | Operation and |
| | Maintenance |
| ODU2 | Optical channel Data |
| | Unit - type 2 |
| OFDM | Orthogonal Frequency |
| | Division Multiplexing |
| OFDMA | Orthogonal Frequency |
| | Division Multiple |
| | Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average |
| | Power Ratio |
| PAR | Peak to Average Ratio |
| PBCH | Physical Broadcast |
| | Channel |
| PC | Power Control, |
| | Personal Computer |
| PCC | Primary Component |
| | Carrier, Primary CC |
| PCell | Primary Cell |
| PCI | Physical Cell ID, |
| | Physical Cell Identity |
| PCEF | Policy and Charging |
| | Enforcement Function |
| PCF | Policy Control |
| | Function |
| PCRF | Policy Control and |
| | Charging Rules |
| | Function |
| PDCP | Packet Data |
| | Convergence Protocol, |
| | Packet Data |
| | Convergence Protocol |
| | layer |
| PDCCH | Physical Downlink |
| | Control Channel |
| PDCP | Packet Data |
| | Convergence Protocol |
| PDN | Packet Data Network, |
| | Public Data Network |
| PDSCH | Physical Downlink |
| | Shared Channel |
| PDU | Protocol Data Unit |
| PEI | Permanent Equipment |
| | Identifiers |
| PFD | Packet Flow |
| | Description |
| P-GW | PDN Gateway |
| PHICH | Physical hybrid-ARQ |
| | indicator channel |
| PHY | Physical layer |
| PLMN | Public Land Mobile |
| | Network |
| PIN | Personal Identification |
| | Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point Protocol |
| PRACH | Physical RACH |
| PRB | Physical resource |
| | block |
| PRG | Physical resource |
| | block group |
| ProSe | Proximity Services, |
| | Proximity-Based |
| | Service |
| PRS | Positioning Reference |
| | Signal |
| PRR | Packet Reception |
| | Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization Signal |
| PSTN | Public Switched |
| | Telephone Network |
| PT-RS | Phase-tracking |
| | reference signal |
| PTT | Push-to-Talk |
| PUCCH | Physical Uplink |
| | Control Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QoS Flow ID, QoS |
| | Flow Identifier |
| QoS | Quality of Service |
| QPSK | Quadrature |
| | (Quaternary) Phase |
| | Shift Keying |
| QZSS | Quasi-Zenith Satellite |
| | System |
| RA-RNTI | Random Access RNTI |
| RAB | Radio Access Bearer, |
| | Random Access Burst |
| RACH | Random Access |
| | Channel |
| RADIUS | Remote Authentication |
| | Dial In User Service |
| RAN | Radio Access Network |
| RAND | RANDom number |
| | (used for |
| | authentication) |
| RAR | Random Access Response |
| RAT | Radio Access |
| | Technology |
| RAU | Routing Area Update |
| RB | Resource block, Radio |
| | Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator |
| | value |
| RL | Radio Link |
| RLC | Radio Link Control, |
| | Radio Link Control |
| | layer |
| RLC AM | RLC Acknowledged |
| | Mode |
| RLC UM | RLC Unacknowledged |
| | Mode |
| RLF | Radio Link Failure |
| RLM | Radio Link Monitoring |
| RLM-RS | Reference Signal for |
| | RLM |
| RM | Registration |
| | Management |
| RMC | Reference |
| | Measurement Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource |
| | Control, Radio |
| | Resource Control layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal Time |
| | difference |
| RTP | Real Time Protocol |
| RTS | Ready-To-Send |
| RTT | Round Trip Time |
| Rx | Reception, Receiving, |
| | Receiver |
| S1AP | S1 Application |
| | Protocol |
| S1-MME | S1 for the control plane |
| S1-U | S1 for the user plane |
| S-GW | Serving Gateway |
| S-RNTI | SRNC Radio Network |
| | Temporary Identity |
| S-TMSI | SAE Temporary |
| | Mobile Station |
| | Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary Component |
| | Carrier, Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data |
| | Adaptation Protocol, |
| | Service Data |
| | Adaptation Protocol |
| | layer |
| SDL | Supplementary |
| | Downlink |
| SDNF | Structured Data |
| | Storage Network |
| | Function |
| SDP | Session Description |
| | Protocol |
| SDSF | Structured Data |
| | Storage Function |
| SDU | Service Data Unit |
| SEAF | Security Anchor |
| | Function |
| SeNB | secondary eNB |
| SEPP | Security Edge |
| | Protection Proxy |
| SFI | Slot format indication |
| SFTD | Space-Frequency Time |
| | Diversity, SFN and |
| | frame timing difference |
| SFN | System Frame Number |
| SgNB | Secondary gNB |
| SGSN | Serving GPRS Support |
| | Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent |
| | CSI RNTI |
| SPS | Semi-Persistent |
| | Scheduling |
| SQN | Sequence number |
| SR | Scheduling Request |
| SRB | Signalling Radio |
| | Bearer |
| SRS | Sounding Reference |
| | Signal |
| SS | Synchronization Signal |
| SSB | Synchronization Signal |
| | Block |
| SSID | Service Set Identifier |
| SS/PBCH | Block |
| SSBRI | SS/PBCH Block |
| | Resource Indicator, |
| | Synchronization Signal |
| | Block Resource |
| | Indicator |
| SSC | Session and Service |
| | Continuity |
| SS-RSRP | Synchronization Signal |
| | based Reference Signal |
| | Received Power |
| SS-RSRQ | Synchronization Signal |
| | based Reference Signal |
| | Received Quality |
| SS-SINR | Synchronization Signal |
| | based Signal to Noise |
| | and Interference Ratio |
| SSS | Secondary |
| | Synchronization Signal |
| SSSG | Search Space Set |
| | Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division Duplex |
| TDM | Time Division Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power |
| | Control |
| TPMI | Transmitting Precoding |
| | Matrix Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN Radio |
| | Network Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured Data |
| | Storage Network |
| | Function |
| UICC | Universal Integrated |
| | Circuit Card |
| UL | Uplink |
| UM | Unacknowledged |
| | Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and Low |
| | Latency |
| USB | Universal Serial Bus |
| USIM | Universal Subscriber |
| | Identity Module |
| USS | UE-specific search |
| | space |
| UTRA | UMTS Terrestrial |
| | Radio Access |
| UTRAN | Universal Terrestrial |
| | Radio Access Network |
| UwPTS | Uplink Pilot Time Slot |
| V2I | Vehicle-to- |
| | Infrastruction |
| V2P | Vehicle-to-Pedestrian |
| V2V | Vehicle-to-Vehicle |
| V2X | Vehicle-to-everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding |
| | Graph |
| VNFFGD | VNF Forwarding |
| | Graph Descriptor |
| VNFM | VNF Manager |
| VoIP | Voice-over-IP, Voice- |
| | over-Internet Protocol |
| VPLMN | Visited Public Land |
| | Mobile Network |
| VPN | Virtual Private |
| | Network |
| VRB | Virtual Resource Block |
| WiMAX | Worldwide |
| | Interoperability for |
| | Microwave Access |
| WLAN | Wireless Local Area |
| | Network |
| WMAN | Wireless Metropolitan |
| | Area Network |
| WPAN | Wireless Personal Area |
| | Network |
| X2-C | X2-Control plane |
| X2-U | X2-User plane |
| XML | eXtensible Markup |
| | Language |
| XRES | EXpected user |
| | RESponse |
| XOR | eXclusive OR |
| ZC | Zadoff-Chu |
| ZP | Zero Po |

The foregoing description provides illustration and description of various example embodiments, but is not intended to be exhaustive or to limit the scope of embodiments to the precise forms disclosed. Modifications and variations are possible in light of the above teachings or may be acquired from practice of various embodiments. Where specific details are set forth in order to describe example embodiments of the disclosure, it should be apparent to one skilled in the art that the disclosure can be practiced without, or with variation of, these specific details. It should be understood, however, that there is no intent to limit the concepts of the present disclosure to the particular forms disclosed, but on the contrary, the intention is to cover all modifications, equivalents, and alternatives consistent with the present disclosure and the appended claims.

What is claimed is:

1. An apparatus for a user equipment (UE) comprising:
processing circuitry configured to:
decode a configuration for a Downlink Control Information (DCI) format for multi-cell scheduling comprising a DCI;
validate the DCI based on whether it is scrambled with a cell radio network temporary identifier (CS-RNTI) or a specific RNTI; and
activate a semi-persistent scheduling physical downlink shared control channel (SPS PDSCH) reception or a Type 2 configured grant physical uplink shared channel (CG PUSCH) transmission; and
release the SPS PDSCH reception or the CG PUSCH transmission based on the validation of the DCI; and
a memory to store the DCI format.

2. The apparatus of claim 1, wherein the processing circuitry is further configured to determine whether the DCI indicates Scell dormancy, a TCI update, or HARQ-ACK codebook transmission/retransmission without scheduling a PDSCH.

3. The apparatus of claim 1, wherein the DCI indicates Scell dormancy, or TCI update, or HARQ-ACK codebook transmission/retransmission without scheduling a PDSCH, if the DCI is scrambled with RNTI and a corresponding bit field in the DCI is validated.

4. The apparatus of claim 1, wherein the DCI indicates no more than one serving cell.

5. The apparatus of claim 1, wherein the DCI indicates one or more cells when scrambled with CS-RNTI and validates the DCI for activation or release by checking the corresponding bit field for the indicated cells.

6. The apparatus of claim 1, wherein the processing circuitry is further configured to apply a single SPS PDSCH or CG PUSCH configuration index bit field commonly for all scheduled cells indicated in the DCI or the cells in a cell group when the DCI activates SPS PDSCH or CG PUSCH with multi-cell scheduling.

7. The apparatus of claim 1, wherein the processing circuitry is further configured to report HARQ-ACK of all activated SPS PDSCHs in the same Physical Uplink Control Channel (PUCCH) when the DCI activates multiple SPS PDSCHs in multiple serving cells.

8. The apparatus of claim 1, wherein the processing circuitry is further configured to report HARQ-ACK of the DCI in HARQ-ACK bit location for a serving cell with the lowest cell index when the DCI releases SPS PDSCHs in multiple serving cells for a type-1 HARQ-ACK codebook.

9. The apparatus of claim 1, wherein the processing circuitry is further configured to transmit HARQ-ACK bit for dynamic TCI indication and HARQ-ACK for SPS PDSCH if a type-2 HARQ-ACK codebook is configured and the DCI indicates Scell dormancy and schedules dynamic PDSCH for one or more indicated cells.

10. A non-transitory computer-readable medium storing computer-executable instructions which when executed by one or more processors result in performing operations comprising:
decoding a configuration for a Downlink Control Information (DCI) format for multi-cell scheduling comprising a DCI;
validating the DCI based on whether it is scrambled with a cell radio network temporary identifier (CS-RNTI) or a specific RNTI; and
activating a semi-persistent scheduling physical downlink shared control channel (SPS PDSCH) reception or a Type 2 configured grant physical uplink shared channel (CG PUSCH) transmission; and
releasing the SPS PDSCH reception or the CG PUSCH transmission based on the validation of the DCI.

11. The non-transitory computer-readable medium of claim 10, wherein the operations further comprise determining whether the DCI indicates Scell dormancy, a TCI update, or HARQ-ACK codebook transmission/retransmission without scheduling a PDSCH.

12. The non-transitory computer-readable medium of claim 10, wherein the DCI indicates Scell dormancy, or TCI update, or HARQ-ACK codebook transmission/retransmission without scheduling a PDSCH, if the DCI is scrambled with RNTI and a corresponding bit field in the DCI is validated.

13. The non-transitory computer-readable medium of claim 10, wherein the DCI indicates no more than one serving cell.

14. The non-transitory computer-readable medium of claim 10, wherein the DCI indicates one or more cells when scrambled with CS-RNTI and validates the DCI for activation or release by checking the corresponding bit field for the indicated cells.

15. The non-transitory computer-readable medium of claim 10, wherein the operations further comprise applying a single SPS PDSCH or CG PUSCH configuration index bit field commonly for all scheduled cells indicated in the DCI or the cells in a cell group when the DCI activates SPS PDSCH or CG PUSCH with multi-cell scheduling.

16. The non-transitory computer-readable medium of claim 10, wherein the operations further comprise reporting HARQ-ACK of all activated SPS PDSCHs in the same Physical Uplink Control Channel (PUCCH) when the DCI activates multiple SPS PDSCHs in multiple serving cells.

17. The non-transitory computer-readable medium of claim 10, wherein the operations further comprise reporting HARQ-ACK of the DCI in HARQ-ACK bit location for a serving cell with the lowest cell index when the DCI releases SPS PDSCHs in multiple serving cells for a type-1 HARQ-ACK codebook.

18. The non-transitory computer-readable medium of claim 10, wherein the operations further comprise transmitting HARQ-ACK bit for dynamic TCI indication and HARQ-ACK for SPS PDSCH if a type-2 HARQ-ACK codebook is configured and the DCI indicates Scell dormancy and schedules dynamic PDSCH for one or more indicated cells.

19. A method comprising:
decoding a configuration for a Downlink Control Information (DCI) format for multi-cell scheduling comprising a DCI;
validating the DCI based on whether it is scrambled with a cell radio network temporary identifier (CS-RNTI) or a specific RNTI; and
activating a semi-persistent scheduling physical downlink shared control channel (SPS PDSCH) reception or a Type 2 configured grant physical uplink shared channel (CG PUSCH) transmission; and
releasing the SPS PDSCH reception or the CG PUSCH transmission based on the validation of the DCI.

20. The method of claim 19, further comprising determining whether the DCI indicates Scell dormancy, a TCI update, or HARQ-ACK codebook transmission/retransmission without scheduling a PDSCH.
